(19) United States
(12) Patent Application Publication
(10) Pub. No.: US 2006/0119897 A1
(43) Pub. Date: Jun. 8, 2006

(54) Output apparatus and program thereof

(76) Inventor: Hiroshi Morikawa, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/521,166

(22) PCT Filed: Dec. 8, 2004
(86) PCT No.: PCT/JP04/18308

§ 371 Date: Jan. 14, 2005

(51) Int. Cl. H04N 1/409

(52) U.S. Cl. 358/3.27

(57) ABSTRACT

Output apparatus including a vectorization unit for vectorizing part of bitmap data into first vector data, a data production unit for producing bitmap data after transformation, and an output unit of outputting that bitmap data. The data production unit includes an inverse transformation unit for transforming first coordinate information of a target dot with an inverse function of a certain calculation, and a color determination unit for determining the color of a dot specified by second coordinate information based on the first vector data and the color of a dot on the bitmap data so that the color determined thereby is setup for a dot specified by first coordinate information, and a control unit for enabling the inverse transformation and the color determination to be performed on all dots on the bitmap data to be outputted. Thereby, jaggy-less bitmap data can be outputted without losing its image quality.

### BACKGROUND OF THE INVENTION

1. Field of the Invention

The present invention relates to output apparatuses such as a printing apparatus capable of printing bitmap data, and a display apparatus capable of displaying bitmap data on a screen.

2. Description of Related Art

As conventional output apparatuses, image processing apparatuses in which bitmap (data is processed by extracting contour vectors from a binary image, smoothing it after an enlargement or reduction process, and then filling a contour represented by the contour vectors are disclosed. (For example, refer to Japanese Published Patent Application No. H8-115416, page 1, FIG. 1, and other.)

In the foregoing apparatuses, bitmap data is reproduced by enlarging or reducing the size of contour vectors that were extracted from the bitmap data. Thereby, a bitmap image, which inherently shows jaggies when enlarged can be reproduced as an image having a ‘jaggy-less’ smoothed contour.

However, they have potential drawbacks. As is often the case with fine details of a design, those portions from which a contour vector can hardly be gained fail to reappear on a reproduced bitmap image that underwent the size-reduction process. Moreover, it is impossible for the conventional output apparatuses to obtain contour vectors from any type of data other than the binary type, and therefore, their application is limited to the handling of binary data. Furthermore, the kind of bitmap data to be handled is also limited, which means that depending on its rendering form, it may still be impossible for those apparatuses to obtain contour vectors that best represent the bitmap image. In other words, a reproduced image that underwent the contour filling may give an impression differing from the original image.

### SUMMARY OF THE INVENTION

Accordingly, in order to overcome the drawbacks inherent in the conventional techniques, an objective of the present invention is to provide an output apparatus capable of transforming and outputting bitmap data. Specifically, this output apparatus includes: a bitmap data storage unit for storing bitmap data; a vectorization unit for producing first vector data by vectorizing at least one part of the bitmap data; a data production unit for producing bitmap data after transformation that is composed of multiple dots having a predetermined positional relationship with a certain position on the bitmap data; and an output unit for outputting the bitmap data after transformation. The data production unit sets up the color of the certain position that is determined based on the first vector data and the color of a dot on the bitmap data for the dot having the predetermined positional relationship with that certain position.

By having such an arrangement as described above, bitmap data having jaggy-less smoothed outlines can be obtained as the bitmap data after transformation.

Another objective of the present invention is to provide an output apparatus capable of transforming and outputting bitmap data. Specifically, this output apparatus includes: a bitmap data storage unit for storing bitmap data; a vectorization unit for producing first vector data by vectorizing at least one part of the bitmap data; a vector data transformation unit for producing second vector data by transforming the first vector data that was produced by the vectorization unit, a data production unit for producing bitmap data after transformation based on the second vector data and the bitmap data; and an output unit for outputting the bitmap data after transformation produced by the data production unit.

By having such an arrangement as described above, bitmap data having jaggy-less smoothed outlines can be obtained as the bitmap data after transformation.

Yet another objective of the present invention is to provide an output apparatus capable of transforming and outputting bitmap data. Specifically, this output apparatus includes: a bitmap data storage unit for storing bitmap data; a vectorization unit for producing first vector data by vectorizing at least one part of the bitmap data; a data production unit for producing bitmap data after transformation based on the inverse function of a certain calculation, the bitmap data, and the first vector data; and an output unit for outputting the bitmap data that was produced by the data production unit. The data production unit includes an inverse transformation unit for producing second coordinate information by inversely transforming first coordinate information that specifies a target dot to be processed, using the inverse function of the certain calculation; a color determination unit for determining the color of a position specified by the second coordinate information, based on the first vector data produced by the vectorization unit and the color of a dot on the bitmap data, and then setting up the color determined thereby for the target dot specified by the first coordinate information; and a control unit for controlling so that the above second coordinate information production by the inverse transformation unit and the above dot color determination by the color determination unit can be performed on all dots on bitmap data to be outputted.

By having such an arrangement described above, bitmap data having jaggy-less smoothed outlines can be obtained as the bitmap data after transformation.

In the above-described output apparatus, the color determination unit determines the color of the target dot specified by the first coordinate information in the following manner. In the case where a line represented by the first vector data that was produced by the vectorization unit passes through a dot including a position specified by the second coordinate information, if that position specified by the second coordinate information is located above that line, the color of a dot immediately above the dot including that position is determined as the color of that position, or if that position is located below that line, the color of a dot immediately below the dot is determined as the color of that position, and then the color determined thereby is setup for the target dot specified by the first coordinate information.

By having such an arrangement described above, the color determination can be simplified, and therefore can be speeded up.

Moreover, in the above-described output apparatus, the color determination unit determines the color of the target dot specified by the first coordinate information in the following manner. In the case where a line represented by the first vector data that was produced by the vectorization unit passes through a dot including a position specified by the second coordinate information, if that position is located on the left hand with respect to that line, the color of a dot immediately on the left, adjacent to the dot including that position is determined as the color of that position, or if that position is located on the right hand, the color of a dot immediately on the right, adjacent to the dot including that position is determined as the color of that position, and then the color determined thereby is setup for the target dot specified by the first coordinate information.

By having such an arrangement as described above, the color determination can be simplified, and therefore can be speeded up.

Yet another objective of the present invention is to provide an output apparatus including: a bitmap data storage unit for storing bitmap data; a bitmap data acquisition unit for acquiring bitmap data from the bitmap data storage unit; a jaggy elimination processing unit for executing processing of eliminating jaggies appearing on the bitmap data; a transformation rule retention unit for retaining at least one bitmap data transformation rule that is composed of a pair of information on certain part of the bitmap data and information indicating vector data that forms an image after transformation of the certain part; a data transformation unit for transforming part of the bitmap data according to the transformation rule; and an output unit for outputting data that is produced based on transformation results from the data transformation unit and processing results from the jaggy elimination processing unit.

By having such an arrangement as described above, bitmap data having jaggy-less smoothed outlines can be obtained. Moreover, in the above arrangement, a dictionary is provided for the bitmap data transformation, and therefore, it becomes possible to modify the contents of that dictionary. Thereby, jaggy elimination is enabled according to the kind of bitmap data.

In the above-described output apparatus, the certain part is a rectangle having the size of n×m (n and m represent a positive integer).

By defining as such, the rule-compliant transformation can be simplified, and therefore can be speeded up.

In the above-described output apparatus, the above n and m is three.

By defining as such, the amount of information retained as the transformation rule can be reduced without impairing the effects yielded by the transformation, and therefore, the capacity of a recording medium incorporated in the output apparatus can be made small.

In addition, yet another objective of the present invention is to provide an output apparatus including: a bitmap data storage unit for storing color bitmap data; a bitmap data acquisition unit for acquiring the color bitmap data from the bitmap data storage unit; a jaggy elimination processing unit for executing processing of eliminating jaggies appearing on the color bitmap data; and an output unit for outputting the data that is produced based on processing results from the jaggy elimination processing unit.

By having such an arrangement as described above, bitmap data having jaggy-less smoothed outlines can be obtained as the bitmap data after transformation.

In the above-described output apparatus, the jaggy elimination processing unit includes a jaggy detection unit for detecting jaggies based on the brightness of a dot on the color bitmap data, and a jaggy elimination unit for eliminating such jaggies.

By having such an arrangement as described above, color bitmap data having jaggy-less smoothed outlines can be obtained after transformation.

Moreover, in the above-described output apparatus, the jaggy elimination processing unit includes a vector data production unit for producing vector data, based on all stair-like straight lines that were detected as jaggies, by drawing a straight line from the midpoint of one straight line to the midpoint of another straight line adjacent thereto.

By having such an arrangement as described above, color bitmap data having more smoothed outlines can be obtained.

Furthermore, the above-described output apparatus includes a color determination unit for determining the color of a dot in the following manner. In the case where a line represented by the vector data that was produced by the vector data production unit passes through that dot, the color of a dot above that dot is determined as the color of an upper side of that dot, and the color of a dot below that dot is determined as the color of a lower side of that dot.

By having such an arrangement as described above, the color determination can be simplified, and therefore can be speeded up.

In addition, the above-described output apparatus includes a color determination unit for determining the color of a dot in the following manner. In the case where a line represented by the vector data that was produced by the vector data production unit passes through that dot, the color of a dot on the left, adjacent to that dot is determined as the color of the left side of that dot, and the color of a dot on the right side is determined as the color of the right side of that dot.

By having such an arrangement as described above, the color determination can be simplified, and therefore can be speeded up.

In accordance with the present invention, bitmap data from which jaggies are eliminated so as to increase its image quality can be outputted.

### BRIEF DESCRIPTION OF ACCOMPANYING DRAWINGS

FIG. 1 is a block diagram illustrating a printing apparatus in accordance with a first embodiment of the present invention.

FIG. 2 is a flowchart depicting operations of the printing apparatus in accordance with the first embodiment of the present invention.

FIG. 3 is a flowchart depicting jaggy elimination processing in accordance with the first embodiment of the present invention.

FIG. 4 presents an example of ‘jagged’ bitmap data that will be printed out in accordance with the first embodiment of the present invention.

FIG. 5 presents an enlarged view of a jaggy taken from FIG. 4 in accordance with the first embodiment of the present invention.

FIG. 6 illustrates how the jaggy in FIG. 5 is eliminated in accordance with the first embodiment of the present invention.

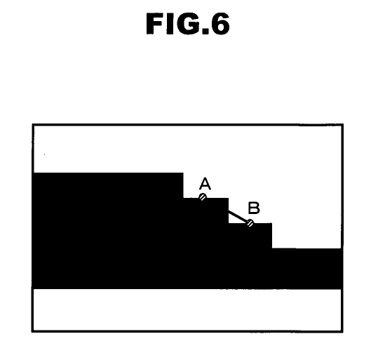

FIG. 7 illustrates an overall picture obtained when the jaggy elimination processing shown in FIG. 6 is repeatedly performed to relevant portions within the bitmap data shown in FIG. 4 in accordance with the first embodiment of the present invention.

FIG. 8 presents a printing example of the bitmap data in FIG. 4 in accordance with the first embodiment of the present invention.

FIG. 9 presents an example of vector data in accordance with the first embodiment of the present invention.

FIG. 10 is a block diagram illustrating a printing apparatus in accordance with a second embodiment of the present invention.

FIG. 11 is a flowchart depicting operations of the printing apparatus in accordance with the second embodiment of the present invention.

FIG. 12 is a flowchart depicting data transformation processing in accordance with the second embodiment of the present invention.

FIG. 13 is a data transformation rule management table, into which data transformation rules in accordance with the second embodiment of the present invention are tabulated.

FIG. 14 presents an example of ‘jagged’ bitmap data in accordance with the second embodiment of the present invention.

FIG. 15 presents an example of applying the data transformation rules in accordance with the second embodiment of the present invention.

FIG. 16 presents an example of bitmap data that underwent the data transformation in accordance with the second embodiment of the present invention.

FIG. 17 is a block diagram of a printing apparatus in accordance with a third embodiment of

FIG. 18 shows, apart from FIG. 13, another variation of data transformation rules in accordance with the third embodiment of the present invention.

FIG. 19 shows original data before transformation in accordance with the third embodiment of the present invention.

FIG. 20 shows data to which the data transformation rules were applied during transformation in accordance with the third embodiment of the present invention.

FIG. 21 shows data to which the data transformation rules were not applied during transformation in accordance with the third embodiment of the present invention.

FIG. 22 presents an example of bitmap data before transformation in accordance with the first embodiment of the present invention.

FIG. 23 presents an example of bitmap data after transformation in accordance with the first embodiment of the present invention.

FIG. 24 presents an explanatory image on how the transformation takes place in accordance with the first embodiment of the present invention.

FIG. 25 presents a printing example of bitmap data in accordance with a prior art.

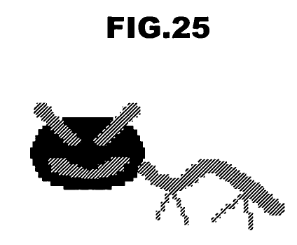

FIG. 26 is a block diagram illustrating an output apparatus in accordance with a fourth embodiment of the present invention.

FIG. 27 is a flowchart depicting operations of the output apparatus in accordance with the fourth embodiment of the present invention.

FIG. 28 is a flowchart depicting processing of producing bitmap data after transformation in accordance with the fourth embodiment of the present invention.

FIG. 29 presents an example of bitmap data before transformation so as to facilitate understanding the operations of the output apparatus in accordance with the fourth embodiment of the present invention.

FIG. 30 presents an example of bitmap data after transformation so as to facilitate understanding of the operations of the output apparatus in accordance with the fourth embodiment of the present invention.

FIG. 31 shows how the output apparatus determines the color of second coordinate information in accordance with the fourth embodiment of the present invention.

FIG. 32 presents an explanatory view illustrating the operations of the output apparatus in accordance with the fourth embodiment of the present invention.

FIG. 33 presents another explanatory view illustrating the operations of the output apparatus in accordance with the fourth embodiment of the present invention.

FIG. 34 presents yet another explanatory view illustrating the operations of the output apparatus in accordance with the fourth embodiment of the present invention.

FIG. 35 presents yet another explanatory view illustrating the operations of the output apparatus in accordance with the fourth embodiment of the present invention.

FIG. 36 presents an explanatory view illustrating the operations of the output apparatus when first vector data is not in use in accordance with the fourth embodiment of the present invention.

FIG. 37 is a block diagram illustrating an output apparatus in accordance with a fifth embodiment of the present invention.

FIG. 38 is a flowchart depicting operations of the output apparatus in accordance with the fifth embodiment of the present invention.

FIG. 39 presents yet another explanatory view illustrating the operations of the output apparatus in accordance with the fourth embodiment of the present invention.

FIG. 40 presents yet another explanatory view illustrating the operations of the output apparatus in accordance with the fourth embodiment of the present invention.

FIG. 41 presents yet another explanatory view illustrating the operations of the output apparatus in accordance with the fourth embodiment of the present invention.

FIG. 42 presents yet another explanatory view illustrating the operations of the output apparatus in accordance with the fourth embodiment of the present invention.

FIG. 43 presents another explanatory view illustrating the operations of the output apparatus when the first vector data is not in use in accordance with the fourth embodiment of the present invention.

### DETAILED DESCRIPTION OF THE PREFERRED EMBODIMENTS

Preferred embodiments of a printing apparatus of the present invention will be discussed hereinafter, making reference to the accompanying drawings. Here note that the same reference numerals are used throughout the drawings and the description in order to refer to the same or similar constituent elements in terms of their behavior or function, and descriptions thereof will not be repeated.

### Embodiment 1.

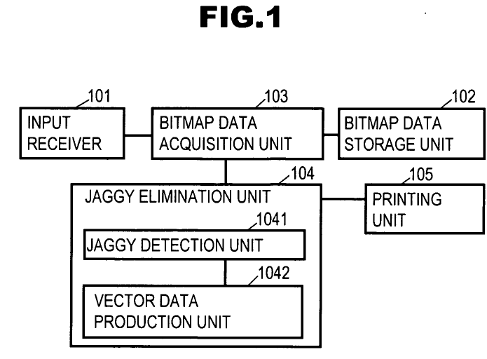

Referring to FIG. 1, a block diagram illustrating a printing apparatus in accordance with a first embodiment of the present invention is shown. This apparatus includes an input receiver 101, a bitmap data storage part 102, a bitmap data acquisition unit 103, a jaggy elimination processing unit 104, and a printing unit 105. The jaggy elimination processing unit 104 includes a jaggy detection unit 1041 and a vector data production unit 1042.

The input receiver 101 receives a printing request command that specifies printing of bitmap data. This command generally contains a data identifier that identifies which bitmap data to be printed out. In order for a user to enter this command, any kind of input means may be feasible, let alone the use of a keyboard or a mouse, or by selecting from a menu screen. The input receiver 101 can be realized by using a apparatus driver that is usually provided together with a keyboard or a mouse, or control software that enables selection from a menu screen.

The bitmap data storage unit 102 stores bitmap data, whose format is irrelevant in this case, and any kind of raster data including Microsoft™ Bitmap is acceptable. For the bitmap data storage unit 102, it is preferable to employ a nonvolatile memory apparatus. However, an alternative volatile type is also feasible. Note that the term “bitmap data” in the first embodiment means a graphic data composed of multiple colored points, hereinafter called a “dot.” Each dot contains color information that specifies its own color. The color information may be black and white binary, or three-valued or more. However, note that in the first embodiment, a graphic composed of multiple dots containing three-valued or many-valued data is considered a color graphic including a gray-scale image. There is no limitation for how the color information represents a color, and therefore, either RGB or CMY format, or even a combination of brightness, saturation, and tone is acceptable. Moreover, any kind of data configuration is feasible so as to create the color information. These features apply to any embodiments other than this.

In response to the request command received by the input receiver 101, the bitmap data acquisition unit 103 reads out bitmap data from the bitmap data storage unit 102. Typically, the data acquisition unit 103 can be formed by using an MPU, a memory and the like, and all processes assigned thereto are realized by software that is stored in a recording medium such as a ROM. However, hardware implementation (using a dedicated circuit) is also feasible.

The jaggy elimination processing unit 104 eliminates jaggies appearing on the bitmap data that was acquired by the bitmap data acquisition unit 103. In order to eliminate a jaggy, any method can be employed. The kind of algorithm that works will be discussed in detail below. Typically, the jaggy elimination processing unit 104 can be formed by using an MPU, a memory, and the like, and all processes assigned thereto are realized by software that is stored in a recording medium such as a ROM. However, hardware implementation (using a dedicated circuit) is also feasible.

After the jaggies appearing on the relevant data were successfully smoothed out, the printing unit 105 then puts that smoothed data into print. The printing unit 105 includes, for example, a printer and its driver software, or may be considered software that enables a printing request command to be sent to an external printer. When proceeding with the printing, it is also feasible that the relevant bitmap data is interpolated so as to increase the amount of data, and therefore have an appropriate resolution for the printing unit 105 to print it out without reducing its size. In the case of printing a graphic composed of vector data, transformation into bitmapped form takes place before proceeding with the actual printing. Generally, this transformation is called rasterization. Since this technique is publicly well-known, a further description is omitted.

The jaggy detection unit 1041 detects jaggies appearing on the bitmap data that was acquired by the bitmap data acquisition unit 103. The jaggy detection is carried out through the following steps: The jaggy detection unit 1041 checks whether there is a jaggy or not for all positions of graphical components within the bitmap data in either a horizontal or vertical direction. The jaggy detection unit 1041 detects multiple straight lines, and obtains a starting point and an end point for each line. If one straight line and its neighboring straight line form a stairstep whose height falls within a predetermined range, the jaggy detection unit 1041 judges that portion is a ‘jaggy.’ In order to setup a “predetermined range” any kinds of setting can be employed from only one value setting such as “one dot” to a range setting such as “one dot to several dots,” or “one dot to dozens of dots.” Note that taking the ease of jaggy detection into account, it is preferable to setup one dot so as to judge a stairstep whose height is one dot to be a jaggy.

The vector data production unit 1042 produces vector data, based on all stair-like straight lines on the jaggies detected by the jaggy detection unit 1041, by drawing a straight line from an approximate midpoint of one straight line to an approximate midpoint of another straight line adjacent thereto. Here the interconnecting point is preferably the median. However, any two points that make a smooth appearance to user's eye are feasible. The vector data includes, for example, a coordinate values representing a starting point and an end point of each straight line. The jaggy detection unit 1041 and the vector data production unit 1042 can typically be formed by using an MPU, a memory, and the like, and all processes assigned thereto are realized by software that is stored in a recording medium such as a ROM. However, hardware implementation (using a dedicated circuit) is also feasible.

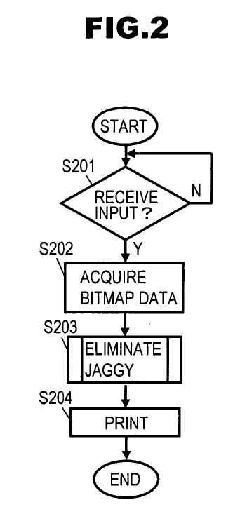

Hereinafter, operations of the printing apparatus in the first embodiment will be discussed by referring to the flowchart shown in FIG. 2.

In step S201, the input receiver 101 checks whether or not a printing request command is received. If the reception is confirmed, it proceeds to step S202; otherwise, it returns to step S201.

In step S202, according to the command received, the bitmap data acquisition unit 103 reads out bitmap data from the bitmap data storage unit 102.

In step S203, the jaggy elimination processing unit 104 commences elimination of jaggies from the bitmap data acquired in step S202. Then, following the jaggy elimination, smoothed data is outputted. How jagged portions are smoothed out will be discussed in detail below.

In step S204, the printing unit 105 prints the data that underwent the jaggy elimination process during step S203, and terminates the ongoing process.

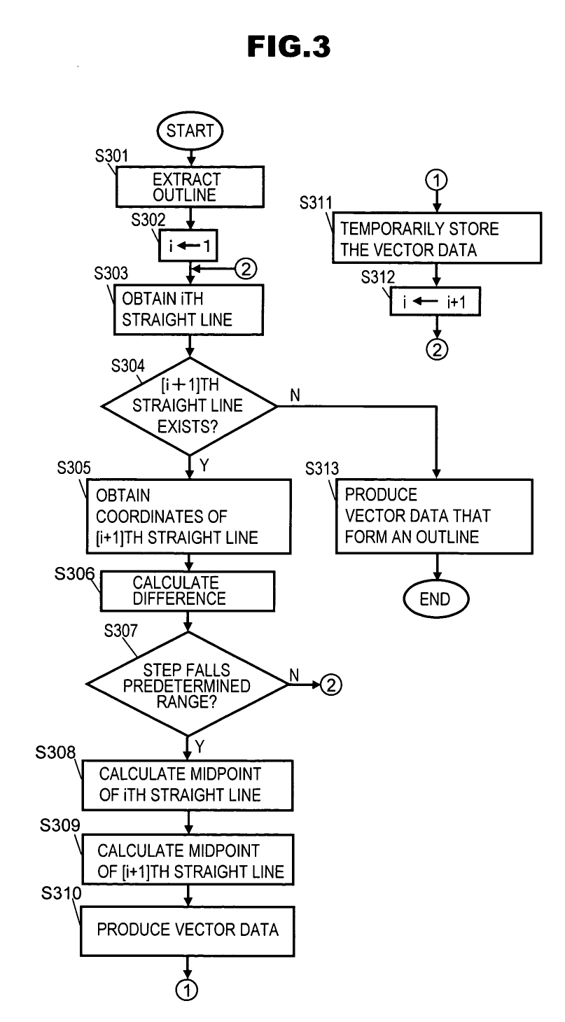

Next, how jaggy elimination is carried out will be discussed by referring to the flowchart shown in FIG. 3.

In step S301, the jaggy detection unit 1041 extracts the outline of bitmap data. Then, multiple straight lines that form that outline are outputted in the form of coordinates representing a starting point and an end point (e.g., x1, y1, x2, y2). (x1, y1) represents a starting point of the ith straight line, while (x2, y2) represents an end point thereof.

In step S302, the jaggy detection unit 1041 enters 1 (one) to a counter i.

In step S303, the jaggy detection unit 1041 obtains coordinates of the ith straight line (x1, y1, x2, y2) among other lines.

In step S304, the jaggy detection unit 1041 checks on the multiple coordinate sets that were outputted in step S301, whether or not the coordinates of the [i+1]th straight line exist. If the relevant coordinates exist, it proceeds to step S305; otherwise, it jumps to step S313.

In step S305, the jaggy detection unit 1041 obtains the coordinates of the [i+1]th straight line (x3, y3, x4, y4). (x3, y3) represents a starting point, while (x4, y4) represents an end point.

In step S306, the jaggy detection unit 1041 obtains the height of a stairstep composed of the two straight lines, using their coordinates (x2, y2) and (x3, y3). The height of a step is in other words a distance between the two sets of coordinates.

In step S307, the jaggy detection unit 1041 checks whether or not the height obtained in step S306 exceeds a predetermined value. If it exceeds that value, the ongoing process proceeds to step S308, or if it does not fall within the predeternined range, it returns to step S303. For the “predetermined range,” any kinds of setting can be employed from only one value setting such as “one dot” to a range setting such as “one dot to dozens of dots.” In this manner, ‘jaggy or not’ judgment is made.

In step S308, the vector data production unit 1042 calculates the midpoint of the ith straight line following the formula {(x1+x2)/2, (y1+y2)/2}.

In step S309, the vector data production unit 1042 calculates the midpoint of the [i+1]th straight line following the formula {(x3+x4)/2, (y3+y4)/2}.

In step S310, the vector data production unit 1042 produces vector data from the calculation results obtained through steps S308 and S309. The resulting vector data becomes {(x1+x2)/2, (y1+y2)/2, (x3+x4)/2, (y3+y4)/2}.

In step S311, the vector data production unit 1042 temporarily stores the vector data produced in step S310.

In step S312, after incrementing the counter i by one, the ongoing process returns to step S303.

In step S313, the vector data production unit 1042 produces vector data that will form the smoothed version of an outline, from the multiple coordinate sets of straight lines that form the jagged outline of the bitmap data and were outputted in step S301, plus at least one set of vector data temporarily stored in step S311. Specifically, among the coordinate values outputted in step S301, those judged ‘non-jaggy’ as well as temporarily-stored vector data in step S311 are sourced into new vector data that will supersede the jagged outline of the bitmapped graphic. The vector data completed thereby forms a ‘jaggy-less’ outline portion. A detailed description on this vector data will be provided below. When the vector data is completed, the ongoing process terminates.

In order to succeed in eliminating jaggies, any method other than the one depicted in FIG. 3 is feasible for step S203. For example, investigating all dots composing a graphical image can be proposed as an alternative method. Where an image is composed of a horizontal dots (along the x-axis) by b vertical dots (along the y-axis), the y-axis moves from 0 to b-1, and for each y-axis value, the x-axis is scanned from 0 to a-1. This sequence can be described using a programming language such as the C language: for (y=0; y<b; y++) {for (x<a+x++) {Scan ( );}}, where a double loop is created so as to repeatedly execute the function Scan for all dots. The function Scan checks whether or not a relevant position is on a jagged stair. After executing Scan, when the jaggy position is confirmed, new information based on the x-axis is added onto the vector data storage unit. When doing so, the judgment on ‘jaggy’ or ‘non-jaggy’ is made with reference to the brightness of a dot. This reference brightness can be obtained by taking the RGB properties composing one dot into account and using the formula {brightness=B+R*2+G*4}, where B, R, and G represent blue, red and green, respectively. Then, comparison is made of the brightness between a dot that is a target of the judgment and its neighboring dots. If the difference in brightness exceeds a predetermined threshold, the two dots in question are judged to be excessively different in brightness; otherwise, at the same level. Then, if multiple consecutive dots at the same level including the target dot excessively differ in brightness in comparison with their neighboring consecutive dots, it is then judged whether those dots including the target dot contain a stairstep. If the height of such a step falls within a predetermined range, that step is judged ‘jaggy.’ In order to setup a range, any number of dots can be applied, and even the setting of only one value is feasible such as “one dot.” Not to mention a range setting such as “one dot to several dots” or “one dot to dozens of dots.” Note that taking the ease of jaggy detection into account, it is preferable to setup one dot so as to judge a stairstep whose height is one dot to be a jaggy. The number of dots subsequent to that stairstep is equal to the length of a jaggy. In other words, if a jaggy has a one-dot length, it forms a stairs slanting at 45 degrees. If a jaggy is as long as 100 dots, it forms a gentle slope.

Apart from the brightness of a dot, color information such as saturation or tone, or RGB properties can be used as a reference for the above ‘jaggy or not’ judgment. However, it is preferable to use the brightness, which has an advantage over the saturation or tone in terms of human visual perception.

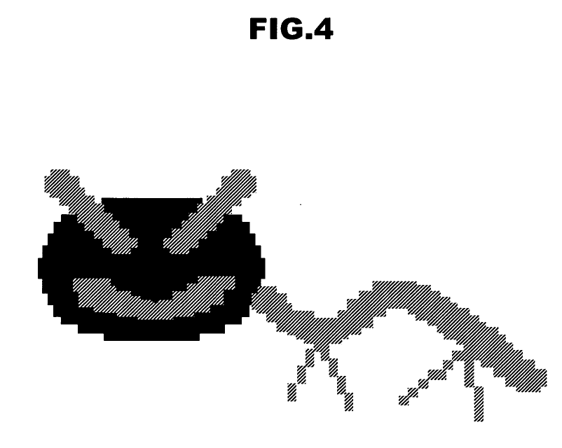

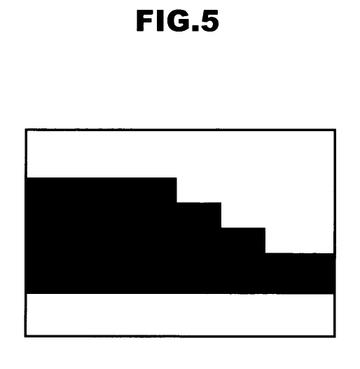

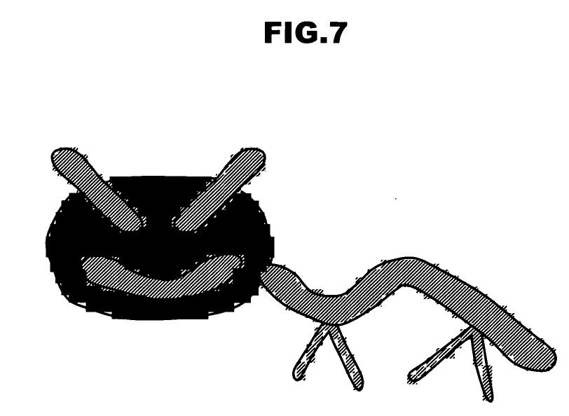

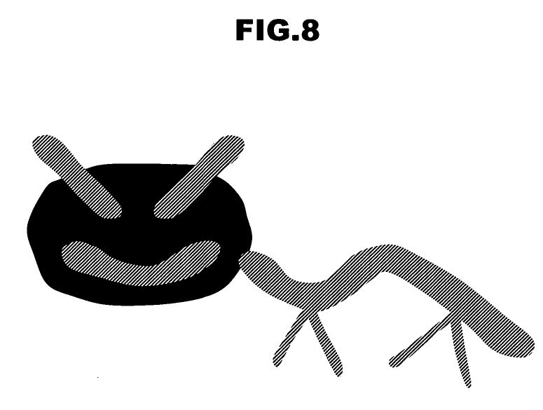

The operations of the printing apparatus in the first embodiment will be discussed hereinafter in detail. FIG. 4 shows bitmap data to be printed, and jaggies (a stair-like portion) appearing on that data are shown enlarged in FIG. 5. Suppose that the printing apparatus has received from a user a printing request that specifies the bitmap data in FIG. 4 to be printed. Subsequent to this reception, the apparatus reads out the relevant bitmap data, and then detects jaggies in FIG. 5. After that, coordinate values are outputted representing a straight line by which two straight lines that form a stairstep falling within the predetermined range are interconnected at each midpoint (point B and point A). This compensation line starts at point A and ends at point B. Likewise, interconnecting two straight lines is repeated to the whole outline portion of the bitmap data, and thereby, as shown in FIG. 7, smoothed data, a bunch of sleek lines is obtained. Then, the printing apparatus prints the data as shown in FIG. 8.

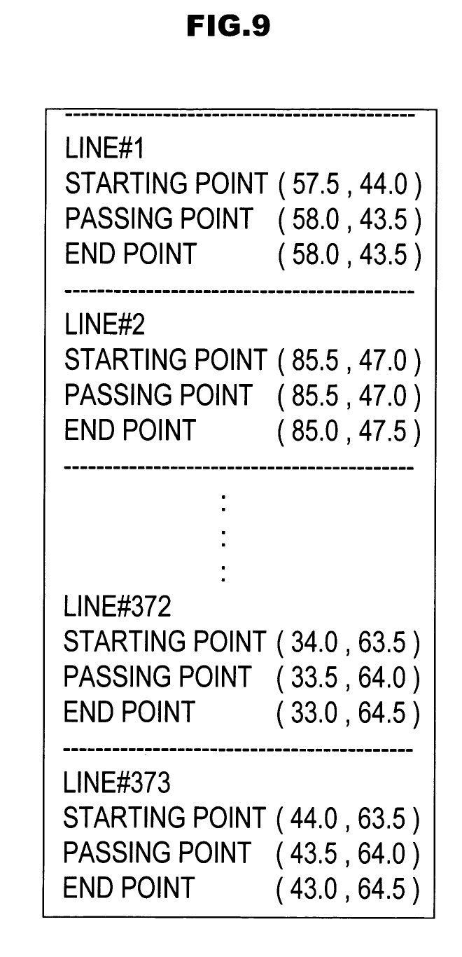

What is utilized in the printing of a smoothed graphic as shown in FIG. 8 is vector data. FIG. 9 shows the one composed of 373 lines, each having a starting point, a passing point, and an end point. Those values inside the parentheses are coordinate (x- and y-axes) values. Using such vector data, smoothed appearance can be realized in output. When doing so, certain portions on which lines represented by vector data run are subject to interpolation so that dots on the lines compose an outline. As the result of this process, bitmap data having a smoothed outline is obtained. Since the application of vector data to an outline of bitmap data is a well-known technique, a further description is omitted.

Thus, in accordance with the first embodiment of the present invention, bitmap data from which jaggies were removed can be printed without sacrificing its actual size.

It is needless to say that the kind of contents is irrelevant to the bitmap data in the first embodiment. However, the effectiveness yielded by the first embodiment will be maximized when handling the results of fluid or gas analysis. A flow of fluid or gas can be visualized accurately without interruption, which makes it easier for a user to explore analysis results, and therefore increases the credibility of the analysis results per se.

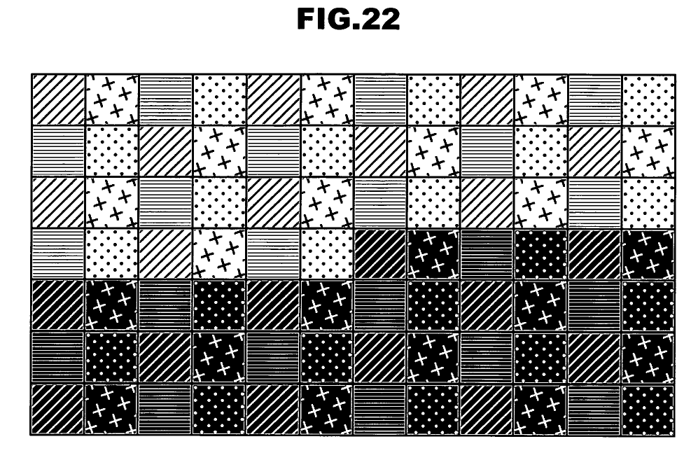

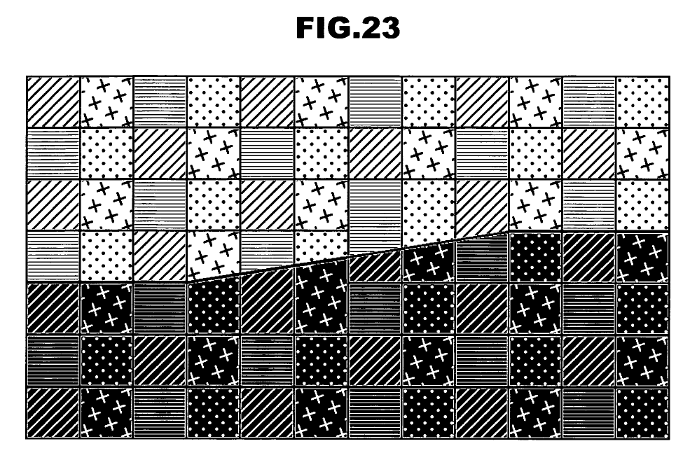

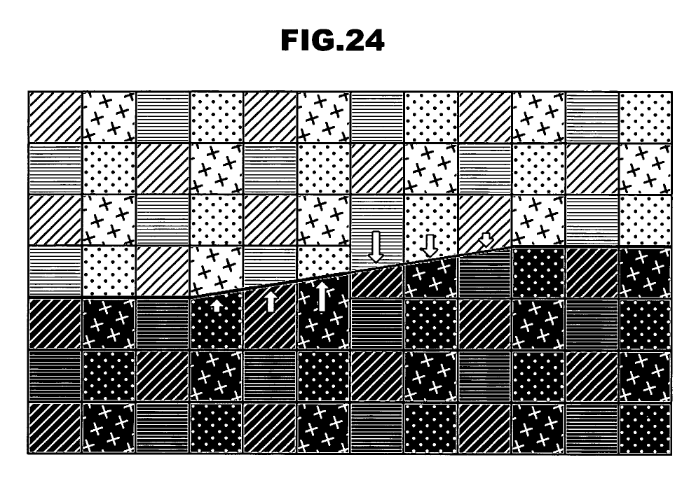

Furthermore, for an image data type, either binary or color is acceptable in the first embodiment. In the case of eliminating rough edges on a color graphic, it is preferable to use a closest color following the processes depicted in FIGS. 22 through 24. Referring first to FIG. 22, ‘jagged’ color bitmap data is shown. As mentioned above, the data is checked (scanned) while shifting by one dot at a time so as to obtain the brightness of each dot. Then, if the brightness is continuously excessive for multiple dots in either a horizontal or vertical direction, that portion is judged a ‘jagged’ stairstep. In the particular example of FIG. 22, a data processing apparatus judges there is a jaggy around the center of the data. Then, as shown in FIG. 23, closest colors (on either upper side or lower side) are setup for relevant dots so as to fade a sheer surface as if rubbing the corner. The arrows shown in FIG. 24 represent either upper-side or lower-side color is properly determined for each dot. Note that small rectangles shown in FIGS. 22 through 24 are composed of multiple dots, and this feature applies to any embodiments other than this.

In accordance with the first embodiment, based on all stair-like straight lines on jaggies that were detected by the jaggy elimination processing unit 1041, the vector data production unit 1042 produces vector data by drawing a straight line from an approximate midpoint of one straight line to an approximate midpoint of another straight line adjacent thereto. However, any two points other than the “midpoints” that make a smooth appearance to user's eye are feasible. For example, an interconnecting line for the vector data may start and end at the one-third of respective two lines. Moreover, the kind of lines composing the vector data is not limited to a straight line, and another feasible kind is a curved line that is tangent to a perpendicular extending from the midpoint of one straight line to the midpoint of another straight line adjacent thereto. In terms of simplified and accelerated processing, it is preferable that the vector data produced by the vector data production unit 1042 should be composed of straight lines, each extending from an approximate midpoint of one straight line to an approximate midpoint of another straight line adjacent thereto.

In accordance with the first embodiment, the vector data contains coordinate values representing a starting point and an end point of each straight line. The “approximate midpoint” mentioned above is preferably the midpoint. However, any points that make a smooth appearance to user's eye can be employed. Typically, the jaggy detection unit 1041 and the vector data production unit 1042 are formed by using an MPU, a memory, and the like, and processes assigned thereto are realized by software that is stored in a recording medium such as a ROM. However, hardware implementation (using a dedicated circuit) is also feasible.

The operations set forth in the first embodiment may be realized by software. Such software may be distributed on the Internet by means of downloading, or may be circulated in a recording medium such as a CD-ROM. This feature also applies to any embodiments other than this. Here note that software capable of realizing the operations of the printing apparatus as discussed in the first embodiment is a computer program that enables a computer to execute the steps of: acquiring bitmap data stored thereon; eliminating jaggies appearing on the bitmap data; and specifying printing of data that is produced based on processing results in the jaggy elimination step.

Furthermore, the above computer program is the one that enables the computer to execute the steps of: acquiring bitmap data stored thereon; eliminating jaggies appearing on the bitmap data; and outputting data that is produced based on processing results in the jaggy elimination step.

### Embodiment 2

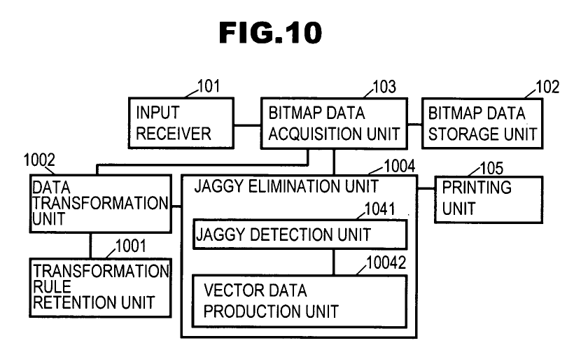

Referring to FIG. 10, a block diagram illustrating a printing apparatus in accordance with a second embodiment of the present invention is shown. This apparatus includes: an input receiver 101; a bitmap data storage unit 102; a bitmap data acquisition unit 103, a transformation rule retention unit 1001; a data transformation unit 1002; a jaggy elimination processing unit 1004; and a printing unit 105. The jaggy elimination processing unit 1004 includes a jaggy detection unit 1041, a vector data production unit 10042.

The rule retention unit 1001 retains at least one rule according to which bitmap data is transformed. The transformation rule is a pair of information on certain part of bitmap data and information indicating vector data that composes an image resulting from the transformation of that certain part. Data configuration of the rule is irrelevant. A detailed description on the transformation rule will be provided below. For the rule retention unit 1001, it is preferable to employ a nonvolatile memory apparatus. However, an alternative volatile type is also feasible.

According to the transformation rule in the rule retention unit 1001, the data transformation unit 1002 transforms part of the bitmap data. Typically, the data transformation unit 1002 can be formed by using an MPU, a memory, and the like, and all processes assigned thereto are realized by software that is stored in a recording medium such as a ROM. However, hardware implementation (using a dedicated circuit) is also feasible.

The jaggy elimination processing unit 1004 eliminates jaggies appearing on the data portions other than the data transformed by the data transformation unit 1002. This means that the transformation process by the transformation unit 1002 precedes the jaggy elimination process. Typically, the jaggy elimination processing unit 1004 can be formed by using an MPU, a memory, and the like, and all processes assigned thereto are realized by software that is stored in a recording medium such as a ROM. However, hardware implementation (using a dedicated circuit) is also feasible.

While giving highest priority to the transformation results, the vector data production unit 10042 produces vector data, based on all stair-like straight lines on jaggies that were detected by the jaggy detection unit 1041, by drawing a straight line from an approximate midpoint of one straight line to an approximate midpoint of another straight lint adjacent thereto.

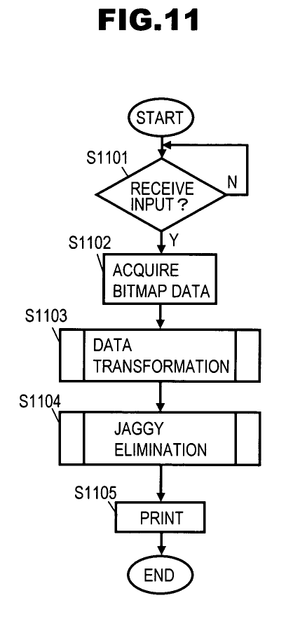

Operations of the printing apparatus in the second embodiment will be discussed hereinafter by referring to the flowchart in FIG. 11.

In step S1101, the input receiver 101 checks whether or not a printing request command is received. If the reception is confirmed, it proceeds to step S1102; otherwise, it returns to S1101.

In step S1102, according to the request command received, the bitmap data acquisition unit 103 reads out bitmap data from the bitmap data storage unit 102.

In step S1103, according to a transformation rule retained in the rule retention unit 1001, the data transformation unit 1002 transforms part of the bitmap data acquired in step S1102. Regarding the transformation process, a detailed description will be provided below.

In step S1104, the jaggy elimination processing unit 104 eliminates jaggies appearing on the bitmap data that underwent the transformation during step S1103. When the jaggy elimination is completed, smoothed data is outputted. A detailed description on this process will be provided below.

In step S1105, the printing unit 105 prints the smoothed data, and terminates the ongoing process.

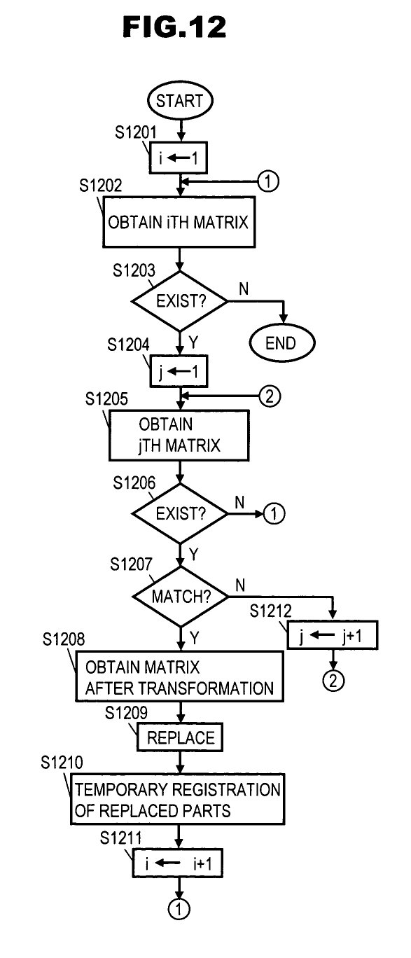

Now, how data transformation takes place during step S1103 will be discussed by referring to the flowchart in FIG. 12.

In step S1201, the data transformation unit 1002 enters 1 (one) to a counter i.

In step S1202, the data transformation unit 1002 obtains the ith matrix from the bitmap data. The matrix is a dot pattern of n×m (n and m represent any integer), and a 3×3 dot pattern is preferable when considering the fact that the total amount of data for dot patterns is small, and the application of a transformation rule has been proved useful in many scenarios. Instead of a matrix, other variations of dot patterns are feasible including a cross, and a group of dots that are not adjacent each other. However, in terms of simplified and accelerated processing, it is preferable to employ a matrix.

Generally, when i is 1, the n×m matrix is obtained from the upper left corner of the bitmap data. Likewise, when i is 2, the matrix is obtained by shifting to right by one dot.

In step S1203, the data transformation unit 1002 checks whether or not the ith matrix was successfully obtained in step S1202. If the relevant matrix is confirmed, it proceeds to step S1204; otherwise, the ongoing process terminates.

In step S1204, the data transformation unit 1002 enters 1 (one) to a counter j.

In step S1205, the transformation unit 1002 obtains a jth matrix before transformation from the rule retention unit 1001. Note that what the rule retention unit 1001 retains is a correspondence table between a matrix before transformation and a matrix after transformation. An example for this will be provided below.

In step S1206, the transformation unit 1002 checks whether or not the jth matrix before transformation exists (i.e., it checks whether or not the jth rule exists). If the relevant matrix is confirmed, it proceeds to step S1207; otherwise, it returns to step S1202.

In step S1207, the transformation unit 1002 checks whether or not the ith matrix obtained in step S1202 matches the jth matrix before transformation obtained in step S1205. If the matching is confirmed, it proceeds to step S1208; otherwise, it jumps to step S1212.

In step S1208, the transformation unit 1002 obtains the jth matrix after transformation from the rule retention unit 1001. The “matrix after transformation” indicates vector data that composes a graphical content resulting from the transformation of a corresponding “matrix before transformation.” In accordance with the second embodiment, a matrix after transformation includes vector data that forms the outline of an image after transformation and color information that defines colors within the outline.

In step S1209, the transformation unit 1002 replaces the ith matrix with the jth matrix.

In step S1210, the transformation unit 1002 temporarily registers parts of the bitmap data that were replaced during step S1209. Those replaced parts are specified using data indicating the coordinates of a relative position within the bitmap data.

In step S1211, after incrementing the counter i by one, the process returns to step S1202.

In step S1212, after incrementing the counter j by one, the process returns to step S1205.

Now, the jaggy elimination taking place during step S1104 will be discussed. Basically, the jaggy elimination processing is the same as the one set forth in the first embodiment, except for one thing: During step S1104, the elimination process is not performed on the particular portions that have been temporarily registered since step S1210, where the transformation rule applied.

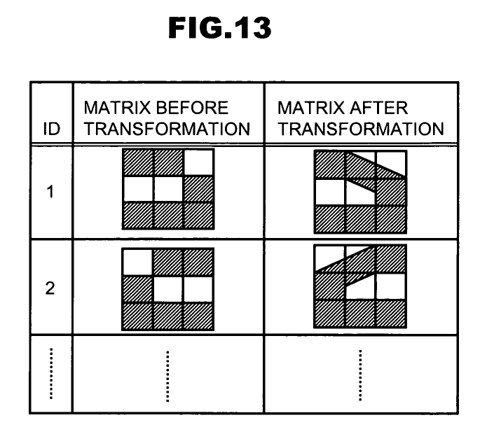

The operations of the printing apparatus in the second embodiment will be discussed hereinafter in detail. FIG. 13 is a data transformation rule management table retained by the rule retention unit 1001. The table is composed of at least one record that contains data under the headings “ID,” “Matrix Before Transformation,” and “Matrix After Transformation.” “ID” is a piece of information uniquely assigned to each record, and is useful in multiple tables management. Both “Matrix Before Transformation” and “Matrix After Transformation” columns contain attribute values. The following will describe how these elements work as a transformation rule. When looking into the contour of a bitmapped graphic, if a pattern that matches any one of the matrices appearing under “Matrix Before Transformation” is found, that pattern is to be replaced with a corresponding matrix appearing under “Matrix After Transformation.”

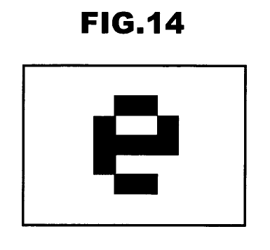

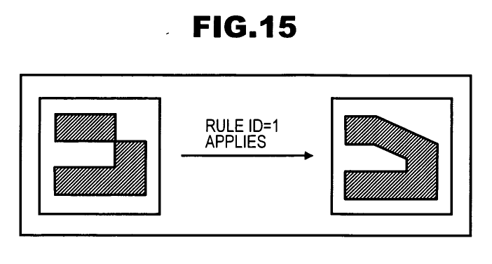

For example, in the case of transforming ‘jagged’ bitmap data “e” in FIG. 14, a data transformation rule whose ID is 1 in FIG. 13 applies as shown in FIG. 15. Following the transformation repeatedly performed, the jaggy elimination set forth in the first embodiment comes next, so that a disedged round “e” that is comfortable to the eye can be obtained in output.

Before printing, a graphic content composed of vector data is always subject to the transformation into the bitmapped form by performing an arithmetic operation. Thanks to this feature, in either case of enlarging or reducing the size of a graphic, the outline smoothing is always performed on the graphic before printing, and its image quality can be kept appropriate for a printing resolution. As a result, smoothly-outlined graphical image is realized in output.

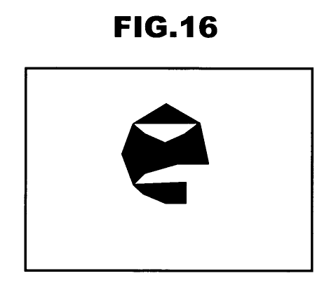

In the second embodiment, if the transformation as set forth above is not performed but the jaggy elimination process is carried out (i.e., if only the processing set forth in the first embodiment is performed), the bitmap data “e” in FIG. 14 becomes the one in FIG. 16, which is odd.

As clarified above, in accordance with the second embodiment, bitmap data can be printed out as a jaggy-less image without changing its actual size. Moreover, adopting certain transformation rules enables graphics to be properly adjusted to a user's preference and to be rendered realistically.

Although what is shown in FIG. 13 is proposed as the transformation rules in the second embodiment, other variations are also feasible. However, even when using the other kinds of rules, it is still preferable that based on 3×3 dot patterns before transformation and vector data that form corresponding graphics of 3×3 dot patterns after transformation, dot patterns that match any one of those before transformation should be replaced with their corresponding vector data after transformation.

The operations set forth in the second embodiment may be realized by software. Such software may be distributed on the Internet by means of downloading, or may be circulated in a recording medium such as a CD-ROM. This feature also applies to any embodiments other than this. Here note that software capable of realizing the operations of the printing apparatus as discussed in the second embodiment is a computer program that enables a computer to execute: a bitmap data acquisition step of acquiring bitmap data stored thereon; a data transformation step of transforming part of the bitmap data according to a data transformation rule stored thereon; a jaggy elimination step of eliminating jaggies appearing on the bitmap data that underwent the transformation in the data transformation step; and a printing request step of specifying printing of data that is produced based on processing results in the jaggy elimination step.

Furthermore, the above computer program is one that enables a computer to execute a bitmap data acquisition step of acquiring bitmap data stored thereon, a data transformation step of transforming part of the bitmap data according to a transformation rule that is a pair of information on certain part of the bitmap data and information indicating vector data that composes an image resulting from the transformation of that certain part: and an output step of outputting data that is produced based on transformation results obtained in the data transformation step and processing results obtained in the jaggy elimination step.

### Embodiment 3

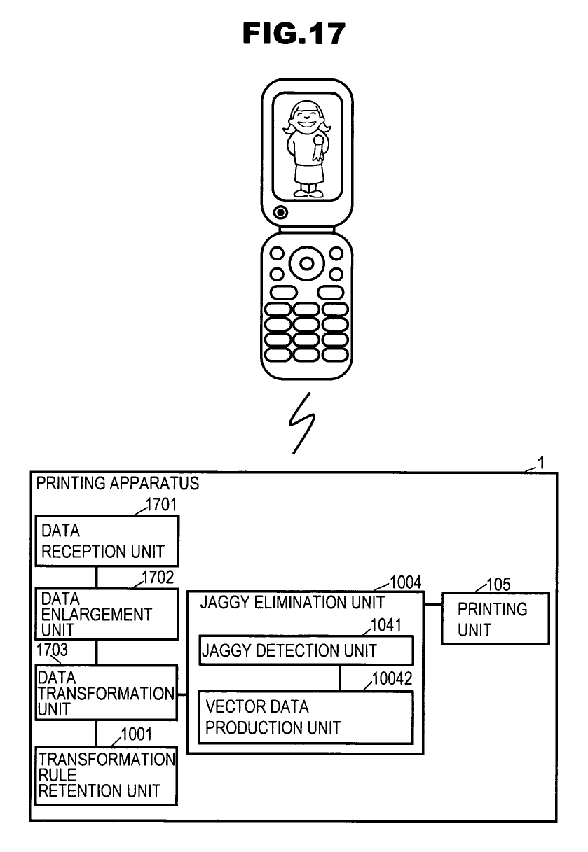

In a third embodiment, a printing apparatus capable of receiving data that was produced by wireless hand-held gadgets such as a mobile phone from them and printing such data will be discussed. Referring to FIG. 17, a block diagram illustrating a printing apparatus in accordance with the third embodiment is shown. This apparatus includes: a data reception unit 1701; a data enlargement unit 1702; a transformation rule retention unit 1001; a data transformation unit 1703; a jaggy elimination processing unit 1004; and a printing unit 105. The jaggy elimination processing unit 1004 includes a jaggy detection unit 1041 and a vector data production unit 10042.

The data reception unit 1701 receives data in a mobile phone or other hand-held gadget from it. In order to receive such data, radio communications such as using infrared waves is preferable. However, using a cable connection is also feasible.

The data enlargement unit 1702 enlarges the data received by the reception unit 1701. Data is enlarged to predetermined paper sizes including A4. Since how to enlarge graphical data is publicly well-known, a further description is omitted. The enlargement unit 1702 can typically be formed by using an MPU, a memory, and the like, and all processes assigned thereto are realized by software that is stored in a recording medium such as a ROM. However, hardware implementation (using a dedicated circuit) is also feasible.

The data transformation unit 1703 transforms part of the data enlarged by the data enlargement unit 1702 according to transformation rules in the rule retention unit 1001. The transformation process employed is the same as the one assigned to the data transformation unit 1002. As the data had been enlarged by the enlargement unit 1702, the amount of jaggies has increased. Then, that ‘jagged’ data undergoes the processing by the transformation unit 1703 as well as the jaggy elimination processing unit 1004 so as to obtain a smoothed appearance.

Operations of the printing apparatus in the third embodiment will be discussed hereinafter. In accordance with the third embodiment, the printing apparatus is capable of receiving and printing images that were, for example, shot by a camera phone (a mobile phone with a build-in camera). When printing out those images, the transformation as well as jaggy elimination processing is performed as mentioned above.

First, a user takes a picture with a camera phone, and then sends that data to the printing apparatus. Upon reception of that data, the printing apparatus proceeds to enlarging to a predetermined size such as A4. After that, part of the enlarged data is transformed according to the transformation rules mentioned above, and the jaggy elimination is performed. Thereby, the user can obtain a smoothly-outlined copy of that picture, large yet high quality.

In accordance with the third embodiment, bitmap data received from wireless gadgets such as a camera phone can be enlarged and printed on a paper. When doing so, extremely smoothed and natural images can be realized. Specifically, hand-held gadgets in general produce poor quality (low-resolution) data, and therefore, jagged surface stick out by nature when printed by means of an ordinary printing technique. On the other hand, incomparably beautiful appearance can be obtained using the apparatus in the third embodiment.

In the third embodiment, neither the transformation unit nor the rule retention unit is indispensable. This means that the printing apparatus in the third embodiment may only be capable of enlarging data received from a camera phone, eliminating jaggies appearing thereon, and printing it out. Another feasible variation is that the data received from a camera phone is not enlarged, but jaggies appearing thereon are eliminated before printing it out. Moreover, the data enlargement unit is not indispensable either, since the printing apparatus only capable of transforming data from a camera phone according to certain transformation rules, eliminating jaggies, and printing it out is also feasible in the third embodiment.

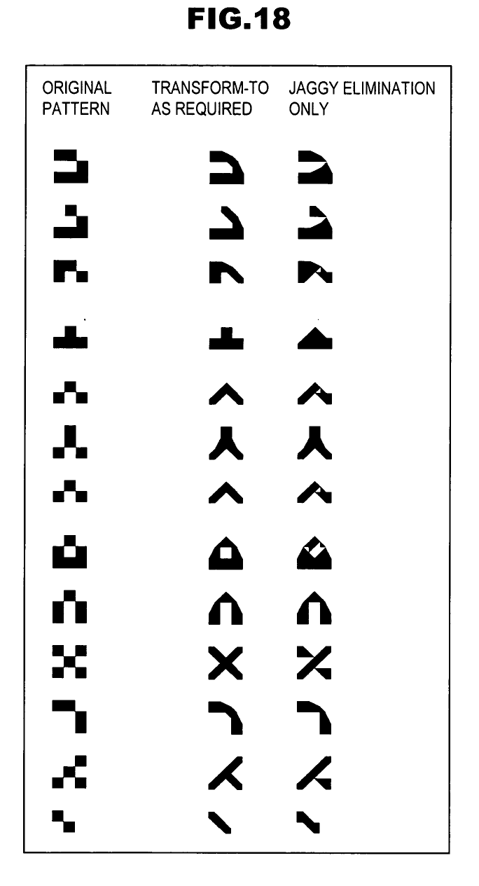

As to the transformation rules, the one shown in FIG. 18 is also applicable. In FIG. 18, rules are managed under the headings “Original Pattern,” “Transform-to as Required,” and “Jaggy Elimination Only.” “Original Pattern” shows dot patterns before transformation. “Transform-to as Required” shows dot patterns after transformation, i.e., dot patterns to which the original patterns are to be transformed. Contrary to it, “Jaggy Elimination Only” shows data whose jaggies were eliminated from the original dot patterns as set forth in the first and other embodiments, without applying the transformation rules. It should be noted that the transformation rules in FIG. 18 is applicable to the second embodiment.

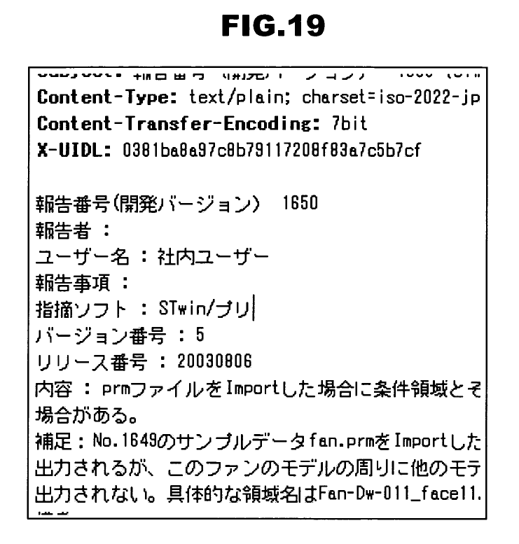

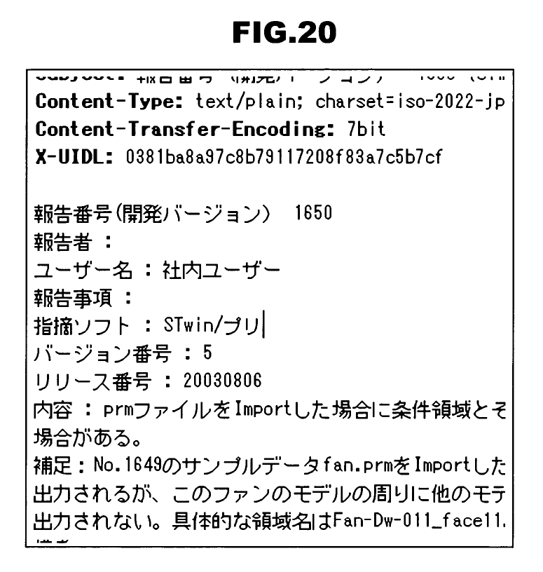

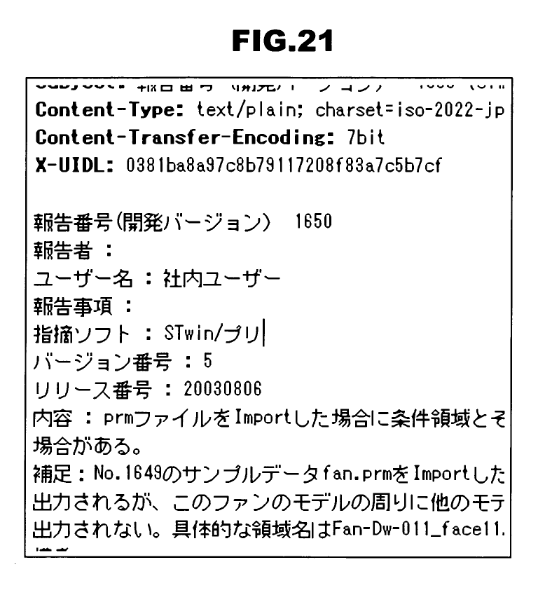

Furthermore, when applying the transformation rules in FIG. 18 to the source data shown in FIG. 19, the resulting data becomes as shown in FIG. 20. Otherwise, the data in FIG. 19 becomes the one shown in FIG. 21.

The first through third embodiments describe the features of the present invention, focusing on a printing apparatus among others. However, application of the present invention extends to an output apparatus and the like that is capable of transferring data to an external display apparatus or a printing apparatus.

### Embodiment 4

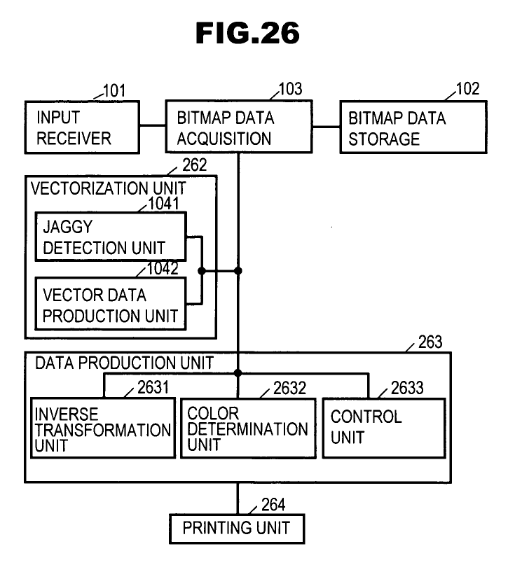

Referring to FIG. 26, a block diagram illustrating an output apparatus in accordance with a fourth embodiment of the present invention is shown. This apparatus includes: an input receiver 101; a bitmap data storage unit 102; a bitmap data acquisition unit 103; a vectorization unit 262; a data production unit 263; and an output unit 264.

The vectorization unit 262 includes a jaggy detection unit 1041 and a vector data production unit 1042.

The data production unit 263 includes an inverse transformation unit 2631, a color determination unit 2632, and a control unit 2633.

Since the input receiver 101, the bitmap data storage unit 102, and the bitmap data acquisition unit 103 are the same as in the first embodiment, a further description is omitted.

However, there is a case where the data acquisition unit 103 can be excluded from the above arrangement. For example, when bitmap data is not read out from the storage unit 102, but is referenced while in the storage unit 102. In such a case, there is no need to include the data acquisition unit 103. Moreover, the data acquisition task can be transferred to other units such as the vectorization unit 262, which acquires bitmap data from the storage unit 102 when required. Furthermore, provided that the output apparatus will automatically commence its processing as soon as bitmap data is placed in the storage unit 102, a command entry specifying that commencement is not necessary, and therefore, the input receiver 101 can be excluded.

The vectorization unit 262 produces first vector data from at least one part of the bitmap data acquired by the bitmap data acquisition unit 103. For example, the vectorization unit 262 produces vector data that is utilized for eliminating jaggies on the bitmap data acquired by the bitmap data acquisition unit 103, or produces vector data that composes an outline of the bitmap data from it. How to produce such vector data is irrelevant. Here, for convenience of explanation, a case where vector data is produced by using the jaggy detection unit 1041 and the vector data production unit 1042 as discussed in the first embodiment is the focus. However, other variations such as the one discussed in the second embodiment are feasible so as to accomplish the same effect.

The data production unit 263 produces bitmap data after transformation based on the inverse function of a certain calculation, the bitmap data acquired by the bitmap data acquisition unit 103, and the first vector data described above. The term “certain calculation” would mean a calculation for executing a certain transformation on the bitmap data acquired by the bitmap data acquisition unit 103. By performing a certain calculation on “bitmap data before transformation,” i.e., bitmap data that has not undergone a certain transformation, “bitmap data after transformation,” i.e., bitmap data that has undergone the certain transformation is created. When coordinate information of the bitmap data before transformation is handed over to the function of this certain calculation, coordinate information of the bitmap data after transformation is obtained. Using this function, the way in which bitmap data is transformed can be altered. Assuming that with the help of the function (f) coordinate information (x, y) of the bitmap data before transformation is altered to coordinate information (X, Y) of the bitmap data after transformation, the function (f) is described as (X, Y)=f(x, y). The coordinate information is provided for specifying a position on bitmap data, and can be composed of coordinate values of two dimensions, for example. Data configuration of the coordinate information is irrelevant. In this manner, using the function of a certain calculation as described above enables coordinate information within bitmap data before transformation to change into coordinate information after transformation, and thereby, bitmap data after transformation is produced. It should, however, be noted that in the fourth embodiment, the inverse function of a certain calculation is employed for producing bitmap data after transformation. Typically, the data production unit 263 can be formed by using an MPU, a memory, and the like, and all processes assigned thereto are realized by software that is stored in a recording medium such as a ROM. However, hardware implementation (using a dedicated circuit) is also feasible.

The inverse transformation unit 2631 produces second coordinate information by inversely transforming first coordinate information that specifies a target dot, using the inverse function (f¹) of the above-described function (f). The “target dot” would mean a dot subject to the processes of the data production unit 263, and more specifically, each dot that composes the bitmap data after transformation produced by the data production unit 263. The first coordinate information is defined as the information specifying each position of the target dots, while the second coordinate information is the information resulting from the inverse transformation of the first coordinate information using the inverse function (f¹). The second coordinate information specifies positions within the original bitmap data that was acquired by the bitmap data acquisition unit 103. The first coordinate information as well as the second is composed of coordinate values of two dimensions, for example. Data configuration is irrelevant in either case. The transformation using the inverse function of the certain calculation function would mean transformation of coordinate values, for example. Typically, the inverse transformation unit 2631 can be formed by using an MPU, a memory, and the like, and all processes assigned thereto are realized by software that is stored in a recording medium such as a ROM. However, hardware implementation (using a dedicated circuit) is also feasible.

The color determination unit 2632 determines the color of a position specified by the second coordinate information, based on the first vector data produced by the vectorization unit 262 and the color of a dot on the bitmap data, so that the color determined thereby is setup for a target dot specified by the first coordinate information. How the color determination progresses in the color determination unit 2632 will be discussed below. For convenience of explanation, the phrase “a dot including a position specified by the second coordinate information” is reworded as a dot represented by the second coordinate information. The “color of a position specified by the second coordinate information” is clipped as the color of the second coordinate information. If a line represented by the first vector data is not placed in such a positional relationship as to pass through a dot represented by the second coordinate information, such a relationship is defined as “non-passing relationship” between the first vector data and a dot represented by the second coordinate information. If it is placed in such a positional relationship as to pass through that dot, it is defined as “passing relationship.”

If the first vector data is in the non-passing relationship with a dot represented by the second coordinate information, the color of that dot is determined as the color of a dot that includes a position specified by the first coordinate information, the information before transforming into the second coordinate information.

If the first vector data is in the passing relationship with a dot represented by the second coordinate information, the color of the second coordinate information is determined based on a position specified by the second coordinate information, the position of the first vector data, and the colors of dots that surround the dot specified by the second coordinate information, or based on the position specified by the second coordinate information, the position of the first vector data, the color of the dot specified by the second coordinate information, and the colors of its surrounding dots.

In order to accomplish the above processing, a variety of conditioning types is feasible. One example is that if a relevant position specified by the second coordinate information is located above a line represented by the first vector data, the color of a dot upwardly adjacent to a dot specified by the second coordinate information, in short, the color of a dot immediately above is determined as the color of the second coordinate information. If that position is located below the line, the color of a dot downwardly adjacent to the dot specified by the second coordinate information, in short, the color of a dot immediately below is determined. Furthermore, if the relevant position is located on the line represented by the first vector data, the color of the second coordinate information is determined according to the color of a dot either immediately above or immediately below the dot specified by the second coordinate information. The type of conditioning may be fixed according to the circumstances, for example, in view of the colors of peripheral dots.

It is also proposed that if a relevant position specified by the second coordinate information is on the left hand with respect to a line represented by the first vector data, the color of a dot leftwardly adjacent to a dot specified by the second coordinate information, in short, the color of a dot immediately on the left, adjacent to the dot is determined as the color of the second coordinate information. If that position is on the right hand with respect to the line, the color of a dot rightwardly adjacent to the dot specified by the second coordinate information, in short, the color of a dot immediately on the right, adjacent to the dot is determined. Furthermore, if the relevant position is located on the line represented by the first vector data, the color of the second coordinate information is determined according to the color of a dot either on the left or right, adjacent to the dot specified by the second coordinate information. The type of conditioning may be fixed according to the circumstances, for example, in view of the colors of peripheral dots.

Alternatively, it is also proposed that if a relevant position specified by the second coordinate information is located above a line represented by the first vector data, the average of the color of a dot immediately above a dot specified by the second coordinate information and the colors of dots on the right and the left, adjacent to the dot is applied. If that position is located below the line, the average of the color of a dot immediately below the dot specified by the second coordinate information and the colors of dots on the right and the left adjacent to the dot is applied. However, when determining the color of the second coordinate information, it is preferable that only one dot adjacent to a dot specified by the second coordinate information should be referenced in terms of the clarity of a resulting image.

In this manner, the color determination progresses in the color determination unit 2632, and as a result, the color of the second coordinate information is obtained as the color of a dot specified by the first coordinate information, the information before transforming into the second coordinate information. After that, the color determination unit 2632 proceeds with temporary storage of the obtained color on a memory or the like. Typically, the color determination unit 2632 can be formed by using an MPU, a memory, and the like, and all processes assigned thereto are realized by software that is stored in a recording medium such as a ROM. However, hardware implementation (using a dedicated circuit) is also feasible.

The control unit 2633 controls so that the second coordinate information production and the color determination processes are performed on all dots within the bitmap data produced by the data production unit 263. There is no limitation on which dot of the bitmap data after transformation is the first to undergo the processes by the inverse transformation unit 2631 and the color determination unit 2632. Typically, the control unit 2633 can be formed by using an MPU, a memory, and the like, and all processes assigned thereto are realized by software that is stored in a recording medium such as a ROM. However, hardware implementation (using a dedicated circuit) is also feasible.

The output unit 264 outputs bitmap data after transformation that was produced by the data production unit 263. The term “output” would mean a display on a screen, printing to a printer, sending of data to other apparatuses, or the like. The output unit 264 may be or may not be provided with an output apparatus such as a display or a printer. Although it was described above that the color determination unit 2632 executes the determination of the color of a dot as well as the temporary memory storage of that color, the latter storage may be passed onto the output unit 264. The output unit 264 can typically be realized by driver software for an output apparatus, or a combination of an output apparatus and its driver software.

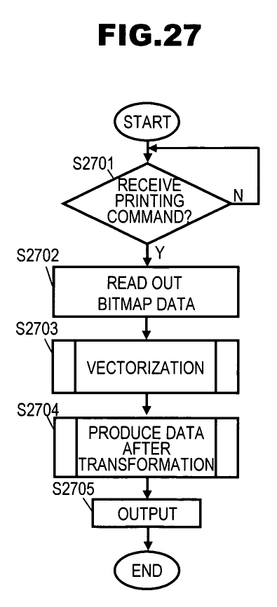

Operations of the output apparatus in the fourth embodiment will be discussed hereinafter by referring to the flowchart shown in FIG. 27.

In step S2701, the input receiver 101 checks whether or not a printing request command is received. If the reception is confirmed, it proceeds to step S2702; otherwise, it returns to step S2701.

In step S2702, according to the request command received, the bitmap data acquisition unit 103 reads out bitmap data from the bitmap data storage unit 102.

In step S2703, the vectorization unit 262 produces first vector data by vectorizing the above bitmap data. Since the vectorization process is the same as in FIG. 3, a further description is omitted.

In step S2704, the data production unit 263 produces bitmap data after transformation based on the bitmap data acquired in step S2702, the first vector data produced in step S2703, and the inverse function of a certain calculation. How to produce the “bitmap data after transformation” will be discussed in detail below.

In step S2705, the output unit 264 receives the bitmap data after transformation that was produced by the data production unit 263 from the color determination unit 2632 of the data production unit 263, and then outputs that data.

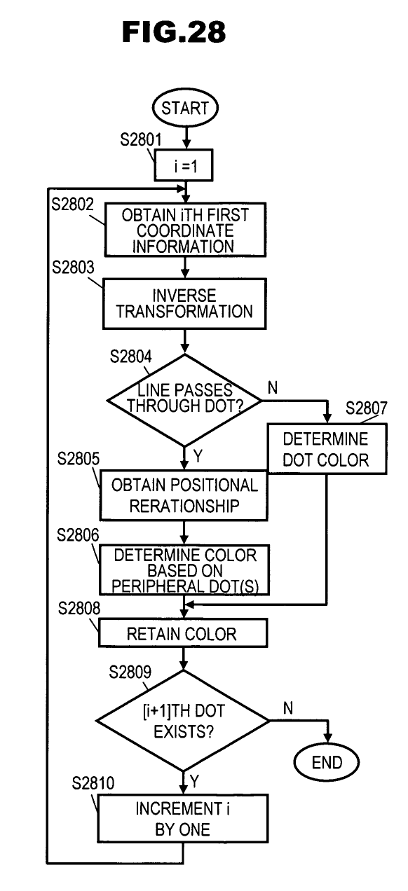

Next, processes performed during step S2704 will be discussed by referring to the flowchart in FIG. 28.

In step S2801, the control unit 2633 enters 1 (one) to a counter i.

In step S2802, the inverse transformation unit 2631 obtains ith first coordinate information specifying an ith dot on bitmap data that will be outputted from the data production unit 263 as bitmap data after transformation.

In step S2803, the inverse transformation unit 2631 obtains ith second coordinate information by inversely transforming the above ith first coordinate information using the inverse function of the certain calculation.

In step S2804, the color determination unit 2632 judges whether or not the first vector data produced by the vectorization unit 262 is in the “passing relationship” with a dot specified by the ith second coordinate information obtained in step S2803 that is on the bitmap data acquired by the bitmap data acquisition unit 103 during step S2702. If the passing relationship is confirmed, it proceeds to step S2805; otherwise, it jumps to step S2807.

In step S2805, the color determination 2632 obtains a positional relationship between a line represented by the first vector data and a position specified by the ith second coordinate information, within the dot specified by the ith second coordinate information obtained in step S2803.

In step S2806, the color determination 2632 determines the color of the position specified by the ith second coordinate information in view of the colors on the periphery of the dot specified by the ith coordinate information, or the colors of the dot specified by the ith coordinate information and its surrounding dots, depending on the positional relationship obtained in step S2805.

In step S2807, the color determination unit 2632 determines the color of the dot specified by the ith second coordinate information as the color of the ith second coordinate information.

In step S2808, the color determination unit 2632 obtains that color determined in either step S2806 or S2807 as the color of the ith dot, and places it on a memory or the like.

In step S2809, the control unit 2633 checks whether or not [i+1]th dot exists on the bitmap data after transformation that was produced by the data production unit 263. If the relevant dot exists, it proceeds to step S2810; otherwise, the ongoing process terminates.

In step S2810, After the control unit 2633 increments the counter i by one, the process returns to step S2802.

Next, an actual example will be given that map data in bitmapped form is changed into a bird's eye view and is sourced out on a display.

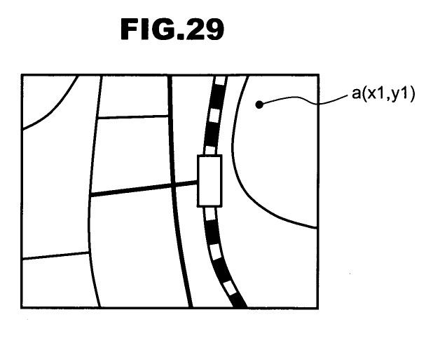

FIG. 29 shows bitmap data that helps understand the actual example of the fourth embodiment. In this example, a map is created in bitmapped form.

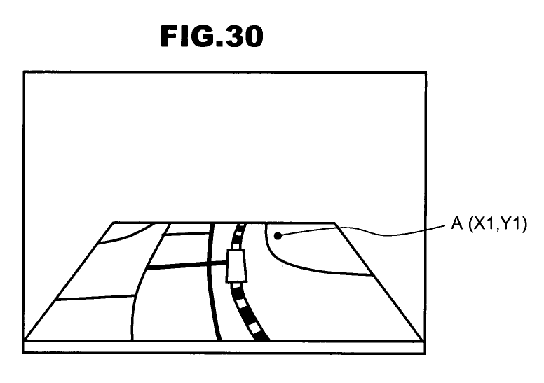

FIG. 30 shows a bird's eye view of the map in bitmapped form that helps understand the actual example of the fourth embodiment. This bitmap data is created from the map data shown in FIG. 29.

In this example, bitmap data as shown in FIG. 29 is transformed so as to create a bird's eye view as shown in FIG. 30 on a display. For this, a calculation is performed so that the coordinate information (x, y) on the bitmap data in FIG. 29 results in the coordinate information (X, Y) on the display of FIG. 30. The function that executes this transformation can be described as (X, Y)=f(x, y). The coordinate information of the bitmap data before transformation undergoes the transformation using the function (f), and then, a color is obtained for a position specified by the coordinate information resulting from the above transformation. Thereby, finalized bitmap data, the data after transformation can be produced.

In the fourth embodiment, however, the function (f) is not utilized for the transformation of the bitmap data. Instead, in order to obtain second coordinate information (x, y) that specifies a position on bitmap data before transformation, the inverse function of the function (f) is executed on the first coordinate information that specifies a dot on the bitmap data after transformation produced by the data production unit 263. This can be described as (x, y)=f¹(X, Y). After that, the color of a position specified by the second coordinate information (x, y) is obtained as the color of a dot that includes the first coordinate information (X, Y). For example, the first coordinate information (X1, Y1) that specifies the position A on the bitmap data after transformation in FIG. 30 is transformed using the inverse function (f¹) into the second coordinate information (x1, y1) that specifies the position a on the bitmap data before transformation in FIG. 29. Then, the color of the position a is setup for a dot including the position A (X1, Y1). When these processes are performed on all dots within the bitmap data in FIG. 30, the bitmap data after transformation is fully created. When doing so, regardless of the first coordinate information expressed as integers in units of dot, the second coordinate information resulting from the inverse transformation may not always have integral values.

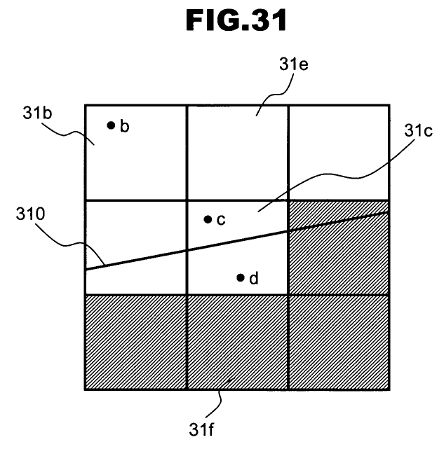

FIG. 31 shows second coordinate information that was transformed from first coordinate information using the inverse function is plotted on bitmap data before transformation. As shown in FIG. 31, the line 310 represented by the first vector data does not pass through the dot 31b that is specified by the second coordinate information b. Therefore, the color of the dot 31b is determined as the color of the second coordinate information b, and then, the color determination unit 2632 stores this color onto a memory or the like as the color setup for a dot including a position specified by the first coordinate information, the information before transforming into the second coordinate information b.

On the other hand, the line 310 passes through the dot including those positions specified by the second coordinate information c, d. Therefore, each color of the second coordinate information c, d is determined based on the positional relationship between the line 310 and the second coordinate information c, d, and the colors of dots immediately above and below the dot 31c that is specified by the second coordinate information c, d. According to the second coordinate information c, the position specified thereby is located above the line represented by the first vector data. Therefore, the color of the dot immediately above the dot 31c, i.e., the dot 31e is referenced as to a color. In this manner, the color of the second coordinate information c is determined. Likewise, the position specified by the second coordinate information d is located below the line. Therefore, the dot immediately below the dot 31c, i.e., the dot 31f is referenced, and its color is determined as the color of the second coordinate information d. Then, these colors determined thereby are placed on a memory or the like by the color determination unit 2632 as the colors setup for a dot that includes a position specified by the first coordinate information. In short, these colors are setup for each corresponding dot on the bitmap data after transformation.

The above color determination is repeated for all dots within the bitmap data after transformation, and when the colors determined are placed on a memory or the like by the color determination unit 2632, the bitmap data after transformation is outputted on a display or the like via the output unit 264.

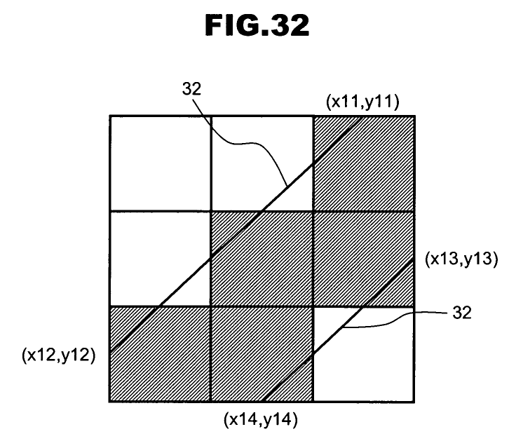

FIGS. 32 through 36 show bitmap data is plotted on diagrams that help understand how bitmap data after transformation is produced in the output apparatus in accordance with the fourth embodiment. When referring to FIGS. 32 through 36, it should be noted that black points represent first or second coordinate information. The color of dots shown in white is called a first color, while the color of hatched dots is a second color. The first and second colors are defined as mutually different, and are not necessarily white and black, respectively. For convenience of explanation, an example where bitmap data is composed of dots having a first or second color is given. It is, however, needless to say that as discussed in the first embodiment, by employing the technique of detecting jaggies on a color graphic, and/or the technique of producing vector data that is utilized for eliminating such jaggies on the color graphic, the present invention is applicable to the case where bitmap data is composed of dots having multiple colors.

Now, how bitmap data after transformation is produced in the output apparatus in accordance with the fourth embodiment will be discussed by referring to the actual examples shown in FIG. 32 through 36.

First, the bitmap data shown in FIG. 32 is acquired by the bitmap data acquisition unit 103, and then, from that data the vectorization unit 262 produces the first vector data 32. In this example, in order to produce the first vector data 32, the vectorization unit 262 judges multiple consecutive dots that have the second color and form a step of one-dot height to be a jaggy. The first vector data 32 is composed of, for example, the coordinate values (x11, y11) and (x12, y12), and the coordinate values (x13, y13) and (x14, y14), where (x11, y11) and (x13, y13) specify a starting point, and (x12, y12) and (x14, y14) an end point of each straight line.

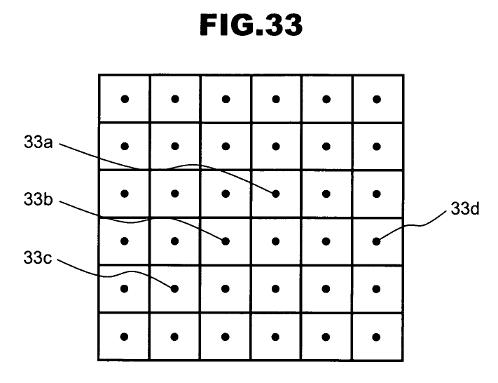

Following the vector data production, the inverse transformation unit 2631 performs the inverse transformation using the inverse function (f¹) of a certain calculation on the bitmap data after transformation shown in FIG. 33. This bitmap data after transformation was produced by the data production unit 263. The target of this inverse transformation is the first coordinate information of each dot. In FIG. 33, each black point inside a dot represents the first coordinate information.

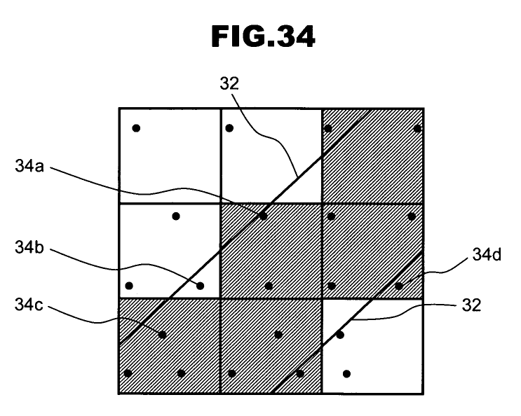

FIG. 34 shows second coordinate information produced by the inverse transformation (f¹) is plotted on bitmap data before transformation. Specifically, through the inversion transformation, the first coordinate information 33a, 33b, 33c, and 33d turned into the second coordinate information 34a, 34b, 34c, and 34d, respectively.

After that, a color is determined for the second coordinate information plotted on the bitmap data in FIG. 34, and then, it is obtained by the color determination unit 2632 as the color a dot including the first coordinate information, the information before transforming into the second coordinate information. In this case, the respective colors of 32a, 32b, 34c, and 34d in FIG. 34 are obtained as the colors of their corresponding dots that include 33a, 33b, 33c, and 33d in FIG. 33.

In the above color determination, if the first vector data 32 is not in the passing relationship with a dot specified by the second coordinate information, the color of that dot is determined as the color of the second coordinate information, and then, it is obtained by the color determination unit 2632 as the color of a dot that includes the first coordinate information, the information before transforming into the second coordinate information.

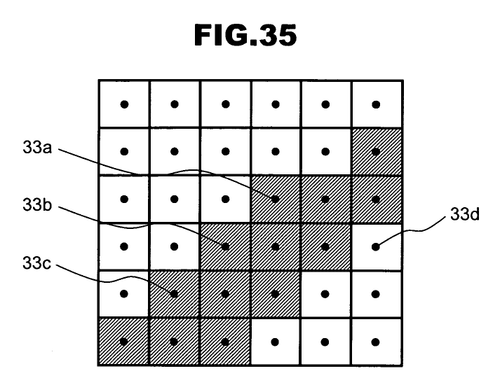

On the other hand, if any dot specified by the second coordinate information is in the passing relationship with the first vector data 32, a judgment is made on the positional relationship between that dot and the vector data 32, i.e., on which side it is located with respect to the data 32 is judged. Then, if it is on the lower side, the color of a dot immediately below the dot that includes the second coordinate information is determined as the color of the second coordinate information. If it is on the upper side, the color of a dot immediately above the dot that includes the second coordinate information is determined. The color determined thereby is then obtained by the color determination unit 2632 as the color of a dot that includes the first coordinate information, the information before transforming into the second coordinate information. The above-described processes are performed on all dots within the bitmap data after transformation, and thereby resulting bitmap data becomes the one shown in FIG. 35.

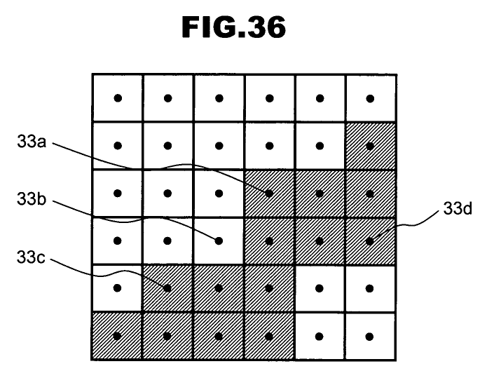

FIG. 36 shows an example of the bitmap data after transformation when color determination for the second coordinate information was performed in a manner different from the fourth embodiment. Since the first vector data 32 is not used, the color of the dot specified by the second coordinate information is determined as the color of the second coordinate information on the bitmap data before transformation in FIG. 34, and that color is obtained as the color of a dot that includes the first coordinate information, the information before transforming into the second coordinate information. In this manner, the bitmap data shown in FIG. 36 is created.

In the example of FIG. 34, the first vector data 32 passes through the dot specified by the second coordinate information 34b, which was obtained by inversely transforming the first coordinate information 33b, and the position specified by 34b is located below the vector data 32. Therefore, in accordance with the fourth embodiment, the color of the dot immediately below the dot specified by 34b, i.e., the second color in this case is determined as the color of 34b, and as shown in FIG. 35, the second color is setup for the dot that includes the first coordinate information 33b, the coordinate information before transforming into 34b. Thereby, the dot including the first coordinate information 33b and its neighboring dots form a jaggy-less smoothed appearance.

However, where color determination is performed in a manner different from the fourth embodiment so as to determine the color of the second coordinate information, the color of the dot specified by 34b is determined as the color of the position specified by 34b. This means that since the fist color is, as shown in FIG. 34, setup for the dot specified by 34b, it is determined that the first color is the color of the position specified by 34b. Then, the first color is setup for the dot including 33b. As the result of this, the dot including 33b and its neighboring dots form a relatively jagged appearance in comparison with the one in FIG. 35.

The dot specified by the second coordinate information 34d in FIG. 34. was obtained by inversely transforming the first coordinate information 33d in FIG. 33. In FIG. 34, the line represented by the first vector data 32 passes through the dot specified by 34d, and the position 34d is below that line. Therefore, in accordance with the fourth embodiment, the color of the dot immediately below the dot specified by 34d , i.e., the first color in this case is determined as the color of 34d , and is setup for the dot including 33d, the coordinate information before transforming into 34d . As the result of this, the dot including 33d and its neighboring dots form a jaggy-less smoothed appearance.

However, where color determination is performed in a manner different from the fourth embodiment so as to determine the color of the second coordinate information, the color of the dot specified by 34d is determined as the color of the position specified by 34d. This means that since the color of the dot specified by 34d belongs to the second color as shown in FIG. 34, the second color is determined as the color of the position specified by 34d and is setup, as shown in FIG. 36, for the dot including 33d, the coordinate information before transforming into 34d. As the result of this, the dot including 33d and its neighboring dots form a relatively jagged appearance in comparison with the one in FIG. 35.

It is possible that after jaggies are removed from bitmap data before transformation, the color determination is performed on coordinates obtained through the inverse transformation. However, where bitmap data before transformation has a low resolution, there is a limit on the dot interpolation that is performed for the jaggy elimination. Specifically, on the bitmap data shown in FIG. 31, the dots including the coordinates 31b, 31c cannot be divided any more. Therefore, if those dots are considered to form a jaggy, it becomes impossible to remove that jaggy at the timing before transformation, and therefore, the jagged edge becomes visible on the finalized data.

It is also possible that after bitmap data undergoes the transformation, the jaggy elimination is performed on it. When doing so, however, the transformation takes place even on jaggies, which as a result turn into a more intricate form. This is so if the transformation means those other than enlargement and reduction. Therefore, in the case where the transformation precedes the jaggy elimination, the jaggy elimination becomes so complicated that problems such as a longer processing time will arise. Moreover, so that the jaggy elimination is performed on bitmap data after transformation, an additional hardware resource such as a memory is required so as to store data that underwent the transformation and is waiting for the jaggy elimination, and therefore, it is unfavorable in terms of downsizing.

As clarified above, in accordance with the fourth embodiment, in the case of transforming bitmap data, jaggies appearing on bitmap data are transformed into first vector data, first coordinate information that specify each dot on bitmap data after transformation undergoes inverse transformation using an inverse function so as to create second coordinate information, the color of a position specified by the second coordinate information is determined using the bitmap data and the first vector data, and the color determined thereby is obtained as the color of a dot on the bitmap data after transformation that includes the first coordinate information, the information before transforming into the second coordinate information. In this manner, as the bitmap data after transformation, bitmap data having jaggy-less smoothed outlines is produced.

In the fourth embodiment, preferably, the data production unit 263 produces bitmap data after transformation that is composed of multiple dots having a predetermined positional relationship with a certain position on bitmap data before transformation, and having the color of the certain position that is determined based on first vector data produced by the vectorization unit 262 and the color of a dot on the bitmap data before transformation.

Specifically, in the fourth embodiment, it is feasible that the data production 263 performs transformation, using the function (f) of a certain calculation, on coordinate information that specifies a certain position on bitmap data before transformation, so that bitmap data produced thereby is composed of multiple dots having a predetermined positional relationship with the certain position on the bitmap data before transformation that is determined by using the function (f). In so doing, the color of each dot on the bitmap data after transformation is setup according to the color of the position specified by the coordinate information on the bitmap data before transformation, and that color is determined, as discussed above in the fourth embodiment, based on the color of a dot on the bitmap data before transformation, the first vector data, and the position specified by coordinate information. These features apply to any embodiments other than this.

Each constituent element set forth in the fourth embodiment can be formed by using hardware such as a dedicated circuit, and constituent elements feasible by software can be realized by executing a computer program. In order to do so, a program executing unit such as a CPU reads out a computer program that is stored in a recording medium such as a hard disk or a semiconductor memory, and executes it. Such software capable of realizing the operations of the output apparatus in the fourth embodiment is a computer program that enables a computer to execute the processing of transforming and outputting bitmap data. In other words, this computer program enables a computer to execute the steps of: producing first vector data by vectorizing at least one part of bitmap data stored thereon; producing bitmap data after transformation that is composed of multiple dots having a predetermined positional relationship with a certain position on the bitmap data and having the color of the certain position that is determined based on the first vector data and the color of a dot on the bitmap data; and outputting the bitmap data after transformation. In addition, a computer program capable of realizing the operations of the output apparatus in the fourth embodiment is a computer program that enables a computer to execute the processing of transforming and outputting bitmap data. In other words, this computer program enables a computer to execute the steps of producing first vector data by vectorizing at least one part of bitmap data stored in the computer; producing bitmap data after transformation based on the inverse function of a certain calculation, the bitmap data, and the first vector data; and outputting the bitmap data after transformation. The data production step includes the steps of: producing second coordinate information by inversely transforming first coordinate information that specifies a target dot, using the inverse function of the certain calculation; determining the color of a position specified by the second coordinate information, based on the first vector data and the color of a dot on the bitmap data, and setting up the color determined thereby for the target dot specified by the first coordinate information; and a control step of controlling so that the step of producing the second coordinate information and the step of setting up the color determined for the target dot specified by the first coordinate information are performed on all dots within bitmap data to be outputted.

### Embodiment 5

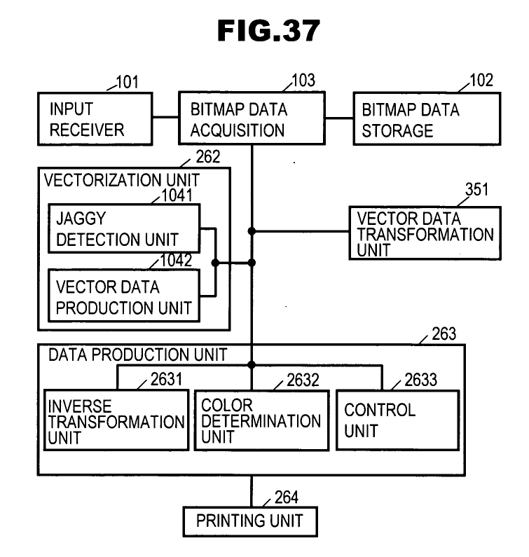

Referring to FIG. 37, a block diagram illustrating an output apparatus in accordance with a fifth embodiment is shown. This apparatus includes: an input receiver 101; a bitmap data storage unit 102; a bitmap data acquisition unit 103; a vectorization unit 262; a data production unit 263; and an output unit 264. The vectorization unit 262 includes a jaggy detection unit 1041, and a vector data production unit 1042. The data production unit 263 includes a color determination unit 2631, an inverse transformation unit 2632, and a control unit 2633.

In accordance with the fifth embodiment, in the output apparatus as discussed in the fourth embodiment, the first vector data produced by the vectorization unit 262 is transformed into second vector data, using the vector data transformation unit 351. Then, based on the second vector data and the bitmap data stored in the bitmap data storage unit 102, the data production unit 263 produces bitmap data after transformation.

The above first-to-second vector data transformation is carried out using the function of a certain calculation. Typically, the vector data transformation unit 351 can be formed by using an MPU, a memory, and the like, and all processes assigned thereto are realized by software that is stored in a recording medium such as a ROM. However, hardware implementation (using a dedicated circuit) is also feasible.

The data production unit 263, which has the same architecture as in the fourth embodiment, and therefore employs the same processing as in the fourth embodiment, produces bitmap data after transformation, based on the first vector data and the bitmap data stored in the bitmap data storage unit 102. In the fifth embodiment, however, in order to transform the first coordinate information on the bitmap data into the second coordinate information as described in the fourth embodiment, the data production unit 263 obtains, from the vector data transformation unit 351, the inverse function (f¹) of the function (f) that was utilized when the vector data transformation unit 351 worked on the transformation of the first vector data into the second vector data.

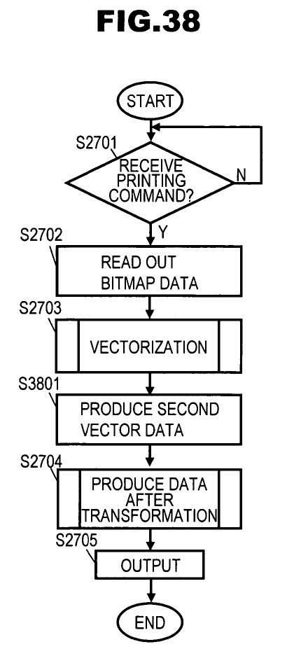

Operations of the output apparatus in accordance with the fifth embodiment will be discussed by referring to the flowchart in FIG. 38. However, the operations other than step S3801 are the same as depicted in FIG. 27; therefore, a description thereon is omitted.

In step S3801, the vector data transformation unit 351 transforms the first vector data produced in step S2703 into second vector data, using the function (f) of a certain calculation. In this step, it is feasible that only lines represented by the first vector data and the second vector data are transformed into bitmapped form so as to be outputted on a display. By so doing, before actual transformation taking place, a user can visually check what sort of transformation will be performed on the first bitmap data, i.e., what sort of function is used so as to accomplish the transformation of that data.

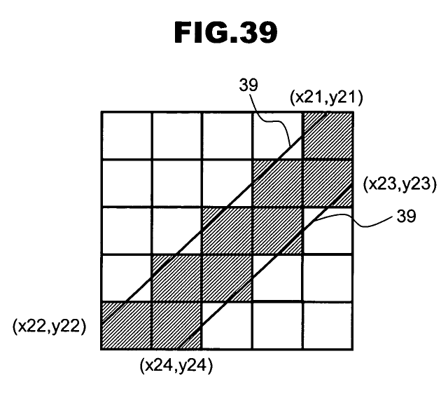

FIGS. 39 through 43 show bitmap data plotted on diagrams that help understand how transformed bitmap data is produced by the output apparatus in accordance with the fifth embodiment. When referring to FIGS. 39 through 45, it should be noted that the color of dots shown in white is called a first color, while the color of hatched dots is a second color. The first and second colors are defined as mutually different, and are not necessarily white and black, respectively. For convenience of explanation, an example where bitmap data is composed of dots having a first or second color is given. It is, however, needless to say that as discussed in the first embodiment, by employing the technique of detecting jaggies on a color graphic, and/or the technique of producing vector data that is utilized for eliminating such jaggies on the color graphic, the present invention is applicable to the case where bitmap data is composed of dot having multiple colors.

First, the bitmap data in FIG. 39 was acquired by the bitmap data acquisition unit 103, and then from that data, the vectorization 262 produces the first vector data 39. The first vector data 39 is composed of, for example, the coordinate values (x21, y21) and (x22, y22), and the coordinate values (x23, y23) and (x24, y24), where (x21, y21) and (x22, y22) specify a starting point, and (x23, y23) and (x24, y24) an end point of each straight line. In this example, in order to produce the first vector data 39, the vectorization unit 262 judges multiple consecutive dots that have the second color and form a step of one-dot height to be a jaggy.

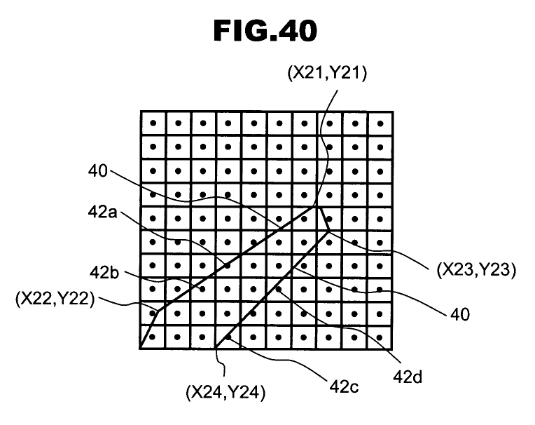

Subsequent to the vector data production, the vector data transformation unit 351 proceeds with the transformation using the function (f) of the certain calculation. In this example, the first vector data 39 undergoes this transformation so as to become the second vector data 40. FIG. 40 shows the lines represented by the second vector data 40 are plotted on the bitmap data after transformation. The second vector data 39 is composed of, for example, the coordinate values (X21, Y21) and (X22, Y22), and the coordinate values (X23, Y23) and (X24, Y24) that were obtained by transforming (x21, y21), (x22, y22), (x23, y23), and (x24, y24), respectively, using the function (f).

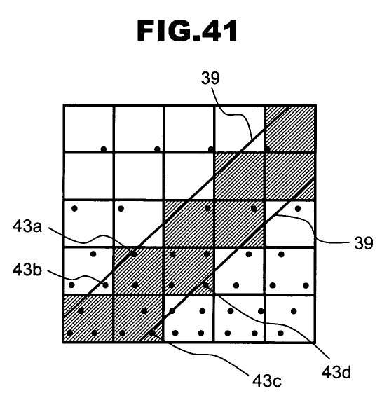

Next, the inverse transformation unit 2631 performs the transformation, using the inverse function (f¹) of the function (f), on the first coordinate information on the bitmap data after transformation shown in FIG. 40, for one dot at a time, so that the first vector data turns into the second vector data. In this figure, black points represent coordinates of each dot, for convenience of explanation. FIG. 41 shows the second coordinate information obtained through the above transformation is plotted on the bitmap data before transformation. The first coordinate information 42a, 42b, 42c, and 42d on the bitmap data after transformation in FIG. 40 are transformed into the second coordinate information 43a, 43b, 43c, and 43d in FIG. 41, respectively.

Then, the color determination 2632 determines the colors of the second coordinate information shown in FIG. 41, and obtains those colors determined as the colors of dots on the bitmap data after transformation including the first coordinate information, the information before transforming into the second coordinate information. Specifically, the colors of 43a, 43b, 43c, and 43d in FIG. 41 are obtained as the colors of the dots including 42a, 42b, 42c, and 42d in FIG. 40.

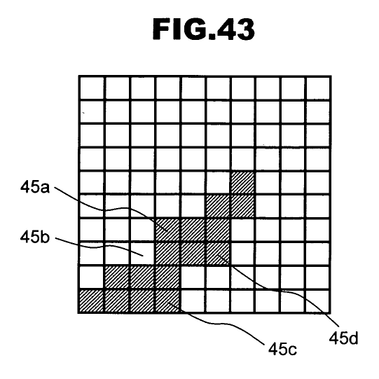

In so doing, on the bitmap data before transformation shown in FIG. 43, if the first vector line 39 does not passes through a dot specified by the second coordinate information, the color of the dot including that second coordinate information is determined as the color of a position specified by the first coordinate information, the information before transforming into the second coordinate information.

If the first vector data 39 passes through a dot specified by the second coordinate information, then, a judgment is made on the positional relationship between the position specified by that second coordinate information and the data 39, i.e., on which side it is located with respect to the data 39. If it is located below, the color of a dot immediately below the dot specified by the second information is determined as the color of the second coordinate information. If it is located above, the color of a dot immediately above the dot is determined.

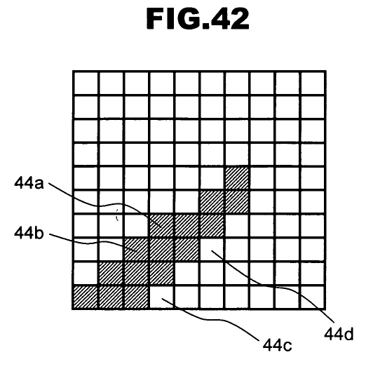

Then, the color determined thereby is obtained as the color of a dot including a position specified by the first coordinate information. All the processes described above are performed on all dots within the bitmap data after transformation, and as a result, the bitmap data as shown in FIG. 42 is produced. In FIG. 42. the reference numerals 44a, 44b, 44c, and 44d represent the dots including the first coordinate information 42a, 42b, 42c, and 42d in FIG. 40, respectively.

FIG. 43 shows bitmap data after transformation when the processes as set forth in the fifth embodiment are not performed at the time of color determination for the second coordinate information. In this example, the first vector data 39 is not referenced, and it is determined that the color of a dot specified by the second coordinate information is the color of a position specified by the second coordinate information on the bitmap data before transformation in FIG. 41, Then, the color of the second coordinate information determined thereby is obtained for a dot including the first coordinate information, the information before transforming into the second coordinate information. In this manner, the bitmap data after transformation shown in FIG. 43 is obtained.

When the dot specified by the first coordinate information 42bin FIG. 40 undergoes the inverse transformation using the inverse function, the resulting second coordinate information becomes the one shown as 43bin FIG. 41, and it is found that the line represented by the first vector data 39 passes through the dot specified by 43b, and the position of 43bis located below that line. Therefore, in accordance with the fifth embodiment, it is determined that the color of a dot immediately below the dot including 43b, i.e., the second color in this case, is the color of the second coordinate information 43b. Then, as shown in FIG. 42, the second color is setup for the dot 44bincluding the first coordinate information 42b, the information before transforming into the second coordinate information 43b. In this manner, the dot 44band its neighboring dots form a jaggy-less smoothed appearance.

On the other hand, where color determination is performed in a manner different from the fifth embodiment so as to determine the color of the second coordinate information, the color of the dot specified by 43bis determined as the color of the position specified by 43b. This means that since the color of 43bis the first color as shown in FIG. 41, it is determined that the first color is the color of the position specified by the second coordinate information 43b. Then, as shown in FIG. 43, the first color is setup for the dot 45b including the first coordinate information 42b, the coordinate information before transforming into 43b. As the result of this, the dot 45b and its neighboring dots form a relatively jagged appearance.

The second coordinate information 43d in FIG. 41 was obtained by inversely transforming the first coordinate information 42d in FIG. 40 using the inverse function. In FIG. 41, the line represented by the first vector data 39 passes through the dot specified by 43d, and the position specified by 43d is located below that line. Therefore, in accordance with the fifth embodiment, the color of a dot immediately below the dot 43d, i.e., the first color in this case is determined as the color of the position 43d. Then, as shown in FIG. 42, the first color is setup for the dot 44d including the position 42d, the information before transforming into 43d. In this manner, the dot 44d and its neighboring dots form a jaggy-less smoothed appearance.

On the other hand, where color determination is performed in a manner different from the fifth embodiment so as to determine the color of the second coordinate information, i.e., where the first vector data 39 is not in use in the course of the color determination, the color of the dot specified by 43d is determined as the color of the position specified by 43d. This means that since the color of 43d is the second color as shown in FIG. 41, it is determined that the second color is the color of the position 43d. Then, as shown in FIG. 43, the second color is setup for the dot 45d including the first coordinate information 42d, the information before transforming into the second coordinate information 43d. As the result of this, the dot 45d and its neighboring dots form a relatively jagged appearance in comparison with the one in FIG. 42, the bitmap data after transformation in accordance with the fifth embodiment.

It is also feasible that in order to determine the color of a position that will be specified by the second coordinate information, a color source can be selected in advance between a dot that will be specified by the second coordinate information and a dot adjacent thereto, before the second coordinate information is obtained using the inverse function (f¹). In so doing, the positional relationship between the second vector data 40 and the first coordinate information on the bitmap data after transformation is referenced. Specifically, if any dot on the bitmap data after transformation is crossed by the second vector data 40, and a position that is specified by the first coordinate information included in that dot is located below the second vector data 40, it is determined that the color of a dot immediately below the dot that will be specified by the second coordinate information will be the color of the second coordinate information, before the second coordinate information is actually obtained using the inverse function (f¹).

As clarified above, in accordance with the fifth embodiment, in the case of transforming bitmap data, first vector data is produced by vectorizing at least one part of relevant bitmap data, the first vector data is transformed into second vector data, second coordinate information is produced by transforming first coordinate information that specifies each dot on bitmap data after transformation, using the inverse function of a calculation utilized when the first vector data was transformed into the second vector data, the color of that second coordinate information is determined based on the bitmap data and the first vector data, and is obtained as the color of a dot on the bitmap data after transformation that includes a position specified by the first coordinate information. In this manner, as the bitmap data after transformation, bitmap data having jaggy-less smoothed outlines is produced.

Each constituent element set forth in the fifth embodiment can be formed by using hardware such as a dedicated circuit, and constituent elements feasible by software can be realized by executing a computer program. In order to do so, a program executing unit such as a CPU reads out a computer program that is stored in a recording medium such as a hard disk or a semiconductor memory, and executes it. Such software capable of realizing the operations of the output apparatus in the fifth embodiment is a computer program that enables a computer to execute the processing of transforming and outputting bitmap data. In other words, this program enables a computer to execute the steps of: producing first vector data by vectorizing at least one part of bitmap data stored in the computer; transforming the first vector data into second vector data; producing bitmap data after transformation based on the second vector data and the bitmap data; and outputting the bitmap data after transformation.

The computer program described in the fifth embodiment does not include any processes performed only by hardware, during the step of obtaining certain information and the step of outputting such data. In short, the processes assigned to the output apparatus during the step of outputting certain information are not considered part of the computer program set forth in the fifth embodiment.

In any one of the first through fifth embodiments, each process or function may be implemented through integrated processing by a single apparatus or system, or alternatively through distributed processing by multiple apparatuses or systems.

Such a computer program as described above may be executed by downloading from a server or the like, or alternatively, by reading out from a laser disc such as a CD-ROM, a magnetic disk, a semiconductor memory, or the like.

In order to execute this program, the number of computers is irrelevant. In other words, either integrated processing or distributed processing is acceptable.

The embodiments of the invention disclosed herein are those considered to be preferred, and various changes and/or modifications can be made without departing from the scope of the invention, and all changes and/or modifications that come within the meaning and range of equivalency of the claims are intended to be embraced therein.

### INDUSTRIAL APPLICABILITY

Output apparatuses of the present invention have the effect of outputting bitmap data from which jaggies are eliminated, and therefore is effective for use as a printing apparatus, display apparatus, and other that is capable of handling bitmap data.

What is claimed is:

1. An output apparatus for transforming and outputting bitmap data comprising:
a bitmap data storage unit for storing bitmap data;
a vectorization unit for producing first vector data by vectorizing at least one part of said bitmap data;
a data production unit for producing bitmap data after transformation that is composed of a plurality of dots having a predetermined positional relationship with a certain position on said bitmap data; and
an output unit for outputting said bitmap data after transformation produced by said data production unit,
said data production unit setting up a color of said certain position that is determined based on said first vector data and a color of a dot on said bitmap data for said dot having said predetermined positional relationship with said certain position.

2. An output apparatus for transforming and outputting bitmap data comprising:
a bitmap data storage unit for storing bitmap data;
a vectorization unit for producing first vector data by vectorizing at least one part of said bitmap data;
a vector data transformation unit for producing second vector data by transforming said first vector data that was produced by said vectorization part;
a data production unit for producing bitmap data after transformation based on said second vector data and said bitmap data; and
an output unit for outputting said bitmap data after transformation produced by said data production unit.

3. An output apparatus for transforming and outputting bitmap data comprising:
a bitmap data storage unit for storing bitmap data;
a vectorization unit for producing first vector data by vectorizing at least one part of said bitmap data;
a data production unit for producing bitmap data after transformation based on an inverse function of a certain calculation, said bitmap data, and said first vector data; and
an output unit for outputting said bitmap data after transformation produced by said data production unit,
said data production unit comprising:
an inverse transformation unit for producing second coordinate information by inversely transforming first coordinate information that specifies a target dot to be processed, using said inverse function of said certain calculation;
a color determination unit for determining a color of a position specified by said second coordinate information, based on said first vector data produced by said vectorization unit and a color of a dot on said bitmap data, and then setting up said color determined thereby for said target dot specified by said first coordinate information; and
a control unit for controlling so that said second coordinate information production by said inverse transformation unit and said dot color determination by said color determination unit can be performed on all dots on bitmap data to be outputted.

4. The output apparatus according to claim 3, wherein:
in a case where a line represented by said first vector data that was produced by said vectorization unit passes through a dot including a position specified by said second coordinate information,
said color determination unit determines in such a manner that if said position is placed above said line, a color of a dot immediately above said dot including said position is determined as a color of said position, or if placed below said line, a color of a dot immediately below said dot including said position is determined as a color of said position, and then sets up said color determined thereby for said target dot specified by said first coordinate information.

5. The output apparatus according to claim 3, wherein:
in a case where a line represented by said first vector data that was produced by said vectorization part passes through a dot including a position specified by said second coordinate information,
said color determination unit determines in such a manner that if said position is placed on a left hand with respect to said line, a color of a dot immediately on a left, adjacent to said dot including said position is determined as a color of said position, or if placed on a right hand, a color of a dot immediately on a right, adjacent to said dot including said position is determined as a color of said position, and then sets up said color determined thereby for said dot specified by said first coordinate information.

6. The output apparatus according to any one of claims 1 through 5, wherein said certain calculation is for forming a bird's eye view.

7. An output apparatus comprising:
a bitmap data storage unit for storing bitmap data;
a bitmap data acquisition unit for acquiring bitmap data from said bitmap data storage unit;
a jaggy elimination processing unit for executing processing of eliminating jaggies appearing on said bitmap data;
a transformation rule retention unit for retaining at least one bitmap data transformation rule that is composed of a pair of information on certain part of said bitmap data and information indicating vector data that forms an image after transformation of said certain part;
a data transformation unit for transforming part of said bitmap data according to said rule; and
an output unit for outputting data that is produced based on transformation results from said data transformation unit and processing results from said jaggy elimination processing unit.

8. The output apparatus according to claim 7, wherein:
said certain part is in a rectangular shape having a size of n X m, where n and m represent a positive integer.

9. The output apparatus according to claim 8, wherein:
said size is 3×3.

10. An output apparatus comprising:
a bitmap data storage unit for storing color bitmap data;
a bitmap data acquisition unit for acquiring said color bitmap data from said color bitmap data storage unit;
a jaggy elimination processing unit for executes processing of eliminating jaggies appearing on said color bitmap data; and
an output unit for outputting data that is produced based on processing results from said jaggy elimination processing unit.

11. The output apparatus according to claim 10, wherein
said jaggy elimination processing unit comprises:
a jaggy detection unit for detecting jaggies based on a brightness of a dot on said color bitmap data, and
a jaggy elimination unit for eliminating said jaggies detected by said jaggy detection unit.

12. The output apparatus according to any one of claims 10 and 11, wherein
said jaggy elimination processing unit further comprises a vector data production unit for producing vector data, based on all stair-like straight lines that were detected as said jaggies, by drawing a straight line from a midpoint of one straight line and a midpoint of another straight line adjacent thereto.

13. The output apparatus according to claim 12, further comprising:
a color determination unit for determining a color of a dot in such a manner that in a case where a line represented by said vector data that was produced by said vector data production unit passes through said dot, a color of a dot above said dot is setup for an upper side of said dot, and a color of a dot below said dot is setup for a lower side of said dot.

14. The output apparatus according to claim 12, further comprising:
a color determination unit for determining a color of a dot in such a manner that in a case where a line represented by said vector data produced by said vector data production unit passes through said dot, a color of a dot on a left, adjacent to said dot is setup for a left side of said dot, and a color of a dot on a right, adjacent to said dot is setup for a right side of said dot.

15. A method for transforming and outputting bitmap data comprising the steps of:
producing first vector data by vectorizing at least one part of bitmap data stored;
producing bitmap data after transformation that is composed of a plurality of dots having a predetermined positional relationship with a certain position on said bitmap data; and
outputting said bitmap data after transformation,
said step of producing bitmap data after transformation, setting up a color of said certain position that is determined based on said first vector data and a color of a dot on said bitmap data for said dot having said predetermined positional relationship with said certain position.

16. A method for transforming and outputting bitmap data comprising the steps of:
producing first vector data by vectorizing at least one part of bitmap data stored;
producing second vector data by transforming said first vector data;
producing bitmap data after transformation based on said second vector data and said bitmap data; and
outputting said bitmap data after transformation.

17. A method for transforming and outputting bitmap data comprising the steps of:
producing first vector data by vectorizing at least one part of bitmap data stored;
producing bitmap data after transformation based on an inverse function of a certain calculation, said bitmap data, and said first vector data; and
outputting said bitmap data after transformation,
said step of producing bitmap data after transformation comprising:
producing second coordinate information by inversely transforming first coordinate information that specifies a target dot to be processed, using said inverse function of said certain calculation;
determining a color of a position specified by said second coordinate information based on said first vector data and a color of a dot on said bitmap data, and then setting up said color determined thereby for said target dot specified by said first coordinate information;
controlling so that said step of producing said second coordinate information and said step of setting up said color determined thereby for said target dot specified by said first coordinate information can be performed on all dots on bitmap data to be outputted.

18. A method for outputting comprising the steps of:
acquiring bitmap data stored;
eliminating jaggies appearing on said bitmap data;
transforming part of said bitmap data according to a transformation rule having a pair of information on certain part of said bitmap data and information indicating vector data that forms an image after transformation of said certain part; and
outputting data that is produced based on transformation results obtained in said data transformation step and processing results obtained in said jaggy elimination step.

19. A method for outputting comprising the steps of:
acquiring color bitmap data stored;
eliminating jaggies appearing on said color bitmap data; and
outputting data that is produced based on processing results obtained in said jaggy elimination step.

20. A computer program that enables a computer to execute processing of transforming and outputting bitmap data, comprising the steps of:
producing first vector data by vectorizing at least one part of bitmap data stored thereon;
producing bitmap data after transformation that is composed of a plurality of dots having a predetermined positional relationship with a certain position on said bitmap data; and
outputting said bitmap data after transformation,
said step of producing bitmap data after transformation, setting up a color of said certain position that is determined based on said first vector data and a color of a dot on said bitmap data for said dot having said certain positional relationship with said certain position.

21. A computer program that enables a computer to execute processing of transforming and outputting bitmap data, comprising the steps of:
producing first vector data by vectorizing at least one part of bitmap data stored thereon;
producing second vector data by transforming said first vector data;
producing bitmap data after transformation based on said second vector data and said bitmap data; and
outputting said bitmap data after transformation.

22. A computer program that enables a computer to execute processing of transforming and outputting bitmap data, comprising the steps of;
producing first vector data by vectorizing at least one part of bitmap data stored thereon;
producing bitmap data after transformation based on an inverse function of a certain calculation, said bitmap data, and said first vector data; and
outputting said bitmap data after transformation,
said step of producing bitmap data after transformation, comprising the steps of:
producing second coordinate information by inversely transforming first coordinate information that specifies a target dot to be processed, using said inverse function of said certain calculation;
determining a color of a position specified by said second coordinate information based on said first vector data and a color of a dot on said bitmap data, and then setting up said color determined thereby for said target dot specified by said first coordinate information; and
controlling so that said step of producing said second coordinate information and said step of setting up said color determined thereby for said target dot can be performed on all dots on bitmap data to be outputted.

23. A computer program that enables a computer to execute the steps of:
acquiring bitmap data stored thereon;
eliminating jaggies appearing on said bitmap data;
transforming part of said bitmap data according to a transformation rule having a pair of information on certain part of said bitmap data and information indicating vector data that forms an image after transformation of said certain part; and
outputting data that is produced based on transformation results obtained in said data transformation step and processing results obtained in said jaggy elimination step.

24. A computer program that enables a computer to execute the steps of:
acquiring color bitmap data stored thereon;
eliminating jaggies appearing on said bitmap data; and
outputting data that is produced based on processing results obtained in said jaggy elimination step.
